(19) United States
(12) Patent Application Publication
(10) Pub. No.: US 2005/0198157 A1
(43) Pub. Date: Sep. 8, 2005

(54) Method and apparatus for a virtual mail house system

(76) Inventors: Mark Andrew Young, Switzerland, FL (US); Timothy Glenn Harris, St. Louis, MO (US)

Correspondence Address: BLACKWELL SANDERS PEPER MARTIN LLP, 720 OLIVE STREET, SUITE 2400, ST. LOUIS, MO, 63101, US

(21) Appl. No.: 10/794,332

(22) Filed: Mar. 5, 2004

(51) Int. Cl. G06F 15/16

(52) U.S. Cl. 709/206

(57) ABSTRACT

The present invention is a Virtual Mail House System that is an Internet-based management of direct mail campaigns from creation through completion that enables real time status reporting for customers. It entails online storage of Databases (a list of addresses to which physical mailers are sent), an online Library (a list of either predefined or user-uploaded documents), a process for creating, managing and tracking the campaign that also maintains a complete history of all activities for both the customer and each record in the database, and fulfillment management and acknowledgement system. The system also provides online contact management which includes the function of maintaining a contact history. When utilizing the present virtual mail house system a user can create a contact database, create a mail campaign, and manage and track the campaign from beginning to end.

### BACKGROUND

1. Field of Invention

The present invention relates to wide area network based information distribution systems and more particularly relates to an internet based mail house system.

2. Background Art

The Internet facilitates methods for instantaneous delivery of information in all forms. It empowers individuals separated by great physical distances to effectively communicate. This allows a single entity to quickly gather information from a variety of sources.

In the field of direct mail management, few options exist which use the internet to its potential. The most obvious implementation currently in the industry is the electronic delivery of a user's database and mailing document. But the relationship between the user and the provider is a temporary one, and repeated yearly mailings become difficult. There is no persistence of a particular address record, unless maintained manually and locally by the user, so the record's history cannot be leveraged to create a more efficient mailing list. There is no “pool of knowledge” that the user may draw on when coming up with a particular marketing piece. There is no long term trending available, and so the efficiency of a mailer never increases.

Current industry requires the users to upload a mailer and a database for immediate processing. Bulk prices are not achieved in this manner, nor can a user benefit from flexible, long term scheduling. There is no mechanism to allow a user to upload an initial database, an initial mailing document and manage that single campaign over the course of weeks, months or years. If call rates get too high, the campaign shouldn't get canceled, it should get rescheduled, or delayed by a week or two.

Other services currently available to the user are Printers, who can provide large quantities of printed materials, and Mail House's, specializing in bulk addressing and mailing. These two services are often not integrated well, and the user may end up doing postage and addressing in house, which is an inefficient method.

### SUMMARY OF INVENTION

The present invention is a Virtual Mail House System that is an Internet-based management of direct mail campaigns from creation through completion that enables real time status reporting for customers. It entails online storage of Databases (a list of addresses to which physical mailers are sent), an online Library (a list of either predefined or user-uploaded documents), a process for creating, managing and tracking the campaign that also maintains a complete history of all activities for both the customer and each record in the database, and fulfillment management and acknowledgement system. The system also provides online contact management which includes the function of maintaining a contact history. When utilizing the present virtual mail house system a user can create a contact database, create a mail campaign, and manage and track the campaign from beginning to end.

The present invention can associate a user with other colleagues in the industry (by establishing a professional organization or their Account Type), such that they become privy to all the marketing pieces that can be accessed by the given account type. These marketing pieces may be carefully written and provided by a professional organization with whom multiple users may be affiliated, and are usually more effective than “home grown” solutions developed by the user. As a particular marketing piece is used by the members of the industry (users who have access based on their account type), it becomes possible for the Library Administrator to adjust or remove the low performing pieces and upgrade the high performing pieces. Without combining the results of all users in a particular industry, the sample size is too small and good versus bad mailers are never identified, without trial and error.

By maintaining all records in a persistent online database, the complete history of all records is always available. As the history is populated, it becomes possible to extract simple information, such as how often an address received a mailer (and which ones), but perhaps more importantly, which ones received the most response (by correlating with website visits, calls and new orders in the weeks following the campaign).

One of the goals of Virtual Mail House is to bring a larger scope to direct mail marketing. By combining detailed campaign and record history over a large period of time, and pooling this data among all common members of a particular industry, all users will benefit from the knowledge. Over time, analysis of this data will reveal more efficient marketing methods, an option not available when working with one-time campaigns in an isolated environment.

The following documentation contains several terms that may be unique to this project, and so require some preliminary definitions. In this context, the User is the entity using the product to create and manage a direct mail campaign, used to target the user's own customers. The Database is the user's collection of unique addresses or contacts. A List is a varying collection of records from the database or a list of contacts. A Campaign is the act of sending out a mailer to one or more addresses or contacts obtained from the database. A Mailer is a printed advertisement. The Library contains several Mailers, which may be used or modified by the user, initially populated by the administrator. The user may also add its own unique mailers to the library. The Printer is the entity responsible for creating the physical mailer. The Mail House is the entity responsible for addressing the mailers, and preparing them to be Dropped at the Post Office. The Account, or Account Type, is the set of users the user belongs to, which allows the user to inherit a set of predefined mailers and other tools, appropriate to the user's business. The set of users can be a trade organization.

This process also entails several user interfaces, each with a specific role. In addition to the User, there are several Administrators. The Account Administrator is the primary entity in charge of maintaining the back end of the system. Responsibilities include managing User accounts, handling accounting, and coordinating with the Printer and Mail House. The Printer Administer is responsible for monitoring incoming campaigns, downloading the User-supplied document, converting it to a final form and printing the required number of copies. The Mail House Administrator is responsible for receiving mailers from the Printer and preparing them to be dropped at the Post Office. The Library Administer is responsible for supplying the default content available in the User's library.

Reference will now be made in detail to the present exemplary embodiments of the invention, examples of which are illustrated in the accompanying drawings. Wherever possible, the same reference numbers will be used throughout the drawings to refer to the same or like parts.

### BRIEF DESCRIPTION OF DRAWING

FIG. 1 is a functional system diagram of a virtual mail house system;

FIG. 1A reflects the database schema of the contact database;

FIG. 2 is a basic functional flow of the contact database operation;

FIGS. 3A and 3B are a basic functional flow of the database add a person funtion;

FIGS. 4A-4C are basic functional flows for the database upload function and the library function;

FIGS. 5A-5C are the functional flows for the campaign creation function;

FIGS. 6A-6C are the functional flows for the configure date functionality;

FIG. 7 is the real time quote functional flow;

FIG. 8 is the account administration interface functional flow;

FIG. 9 is the database administration interface functional flow;

FIG. 10 is the library administration interface functional flow;

FIG. 11 is the printer adminstration interface functional flow;

FIG. 12 is the mail house administration interface functional flow;

FIGS. 13A-13H are the functional flows for a typical user interaction with system; and

FIGS. 14-23 are representative screen shot reflecting the various functional interfaces.

### DETAILED DESCRIPTION

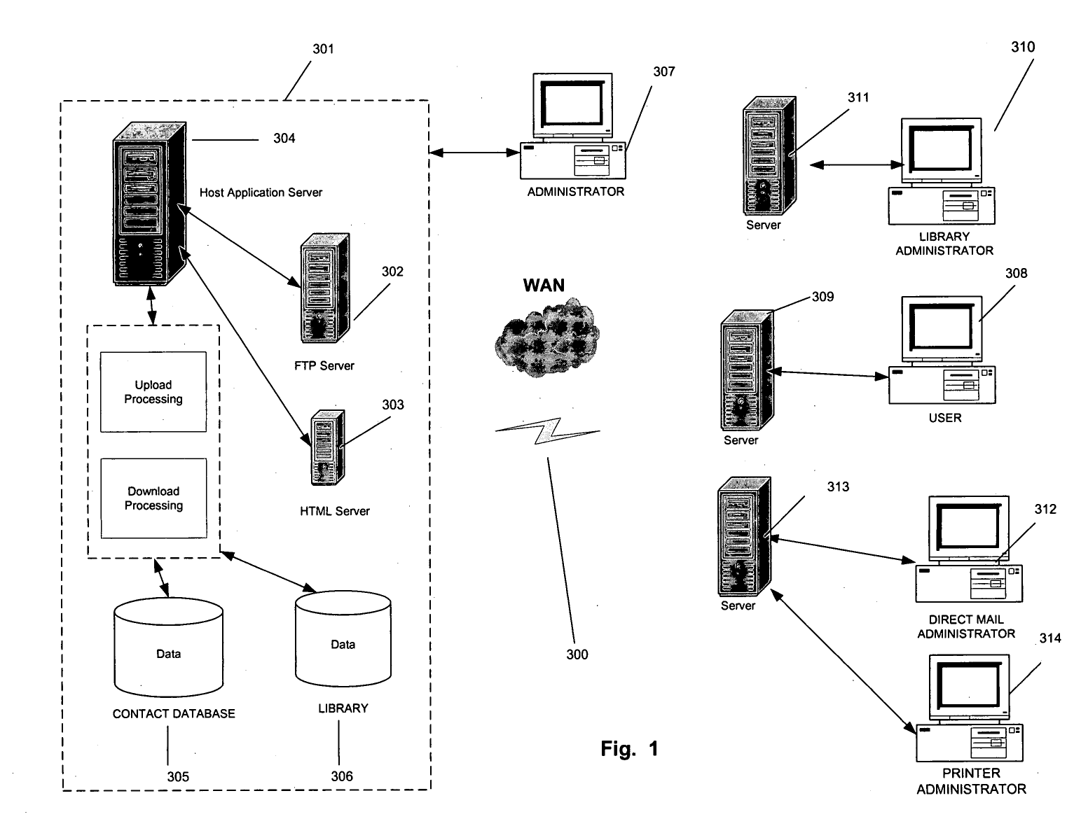

Referring to FIG. 1, the Virtual Mail House System 301, the subject invention of the present application, in one embodiment is a web based system having various user interface portals 310, 308, 312, 314, 307 which access and uses the Mail House System application resident on a host server 304. The Mail House System application includes two main functional sections and they are the operational section and the administration sections. The operational portion is described below in the section entitled Description of Modules and Processes and the administration portion in the section entitled Description of Administrative Modules and Processes.

### Description of Modules and Processes

Database

A list of names and addresses, and optionally, associated demographic data is stored in a SQL database 305. Key fields, such as zip code, last name or any common searchable field, index each record. Each record can be referred to as a contact and each record can contain fields of information, which includes name, postal address, city, state and zip code.

The database will not allow the same address to exist in the database more than once. This improves the overall efficiency of the database, and reduces cost to the customer, by avoiding the charges incurred by sending the same mailer to the same address multiple times.

Each record may be a member of one or more lists of records. These Lists allow the user to create either categorical groups of addresses, or simply to group together a single set of uploaded addresses from a single source. A categorical grouping or list contains records that fall within a category such as for example contacts that have actually received service.

When a campaign is created, the present invention allows the user to combine names from several lists into one single set of addresses. The final set of addresses does not contain duplicates, even if the address appears in more than one of the lists.

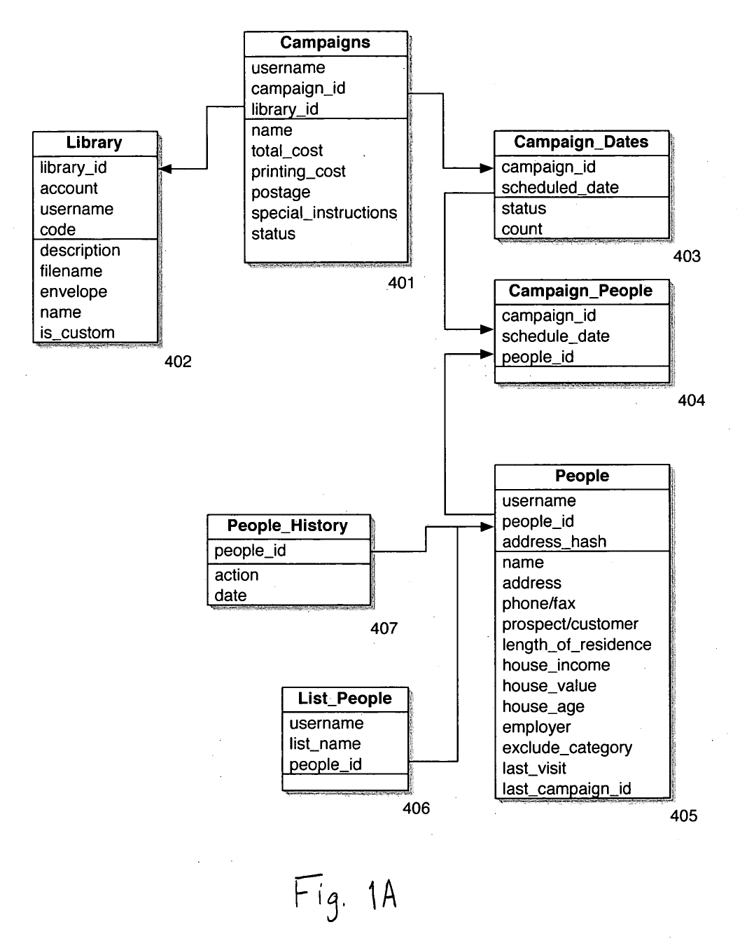

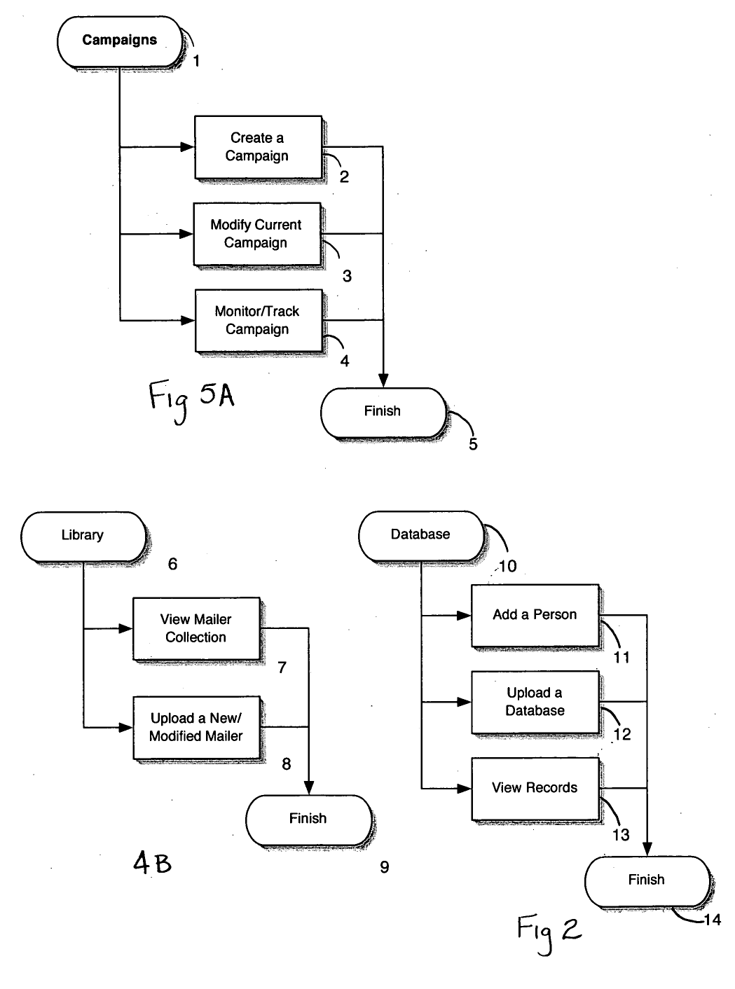

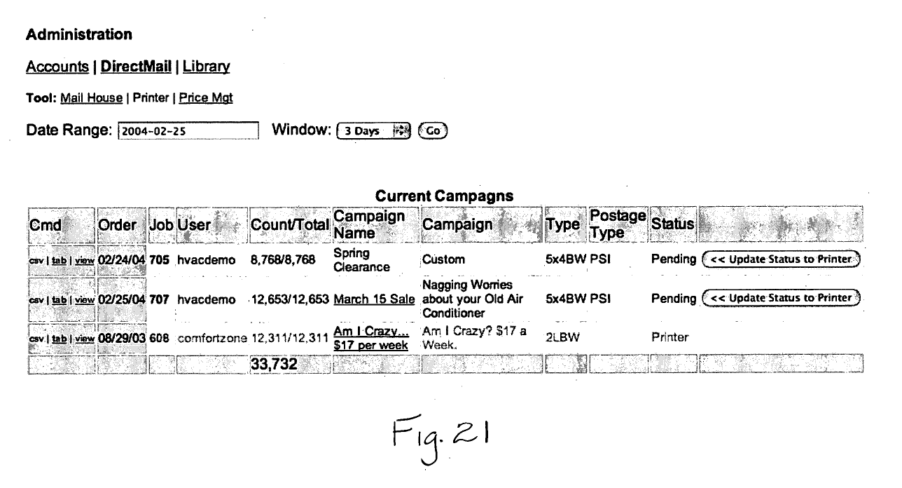

Referring to FIG. 2, Contact addresses are added to the database 10 through a variety of channels. A contact address may be entered manually 11, may be added as the result of a web-based form (FIG. 20), or may be imported in volume from an external data source 12. The user may also view 13 the user's addresses prior to completing 14 the users database.

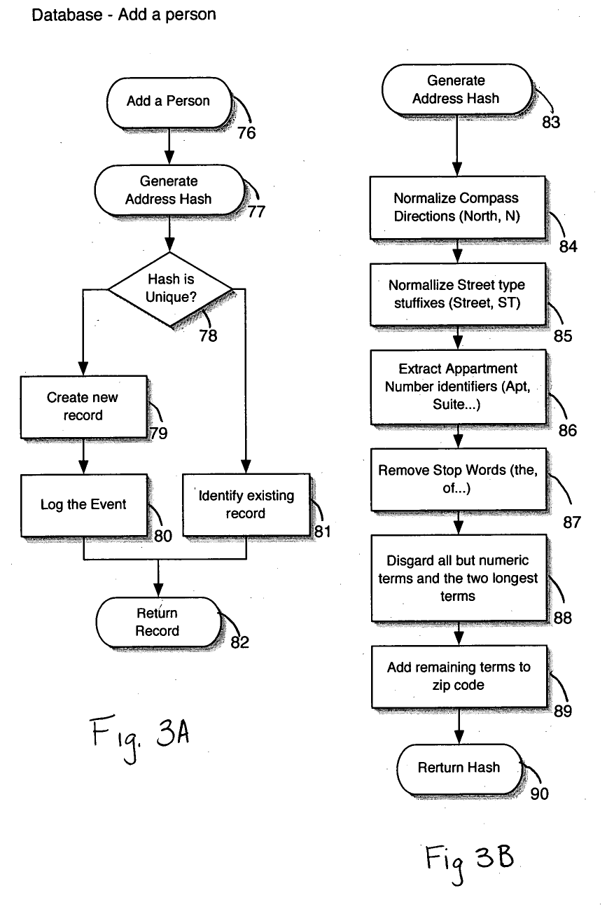

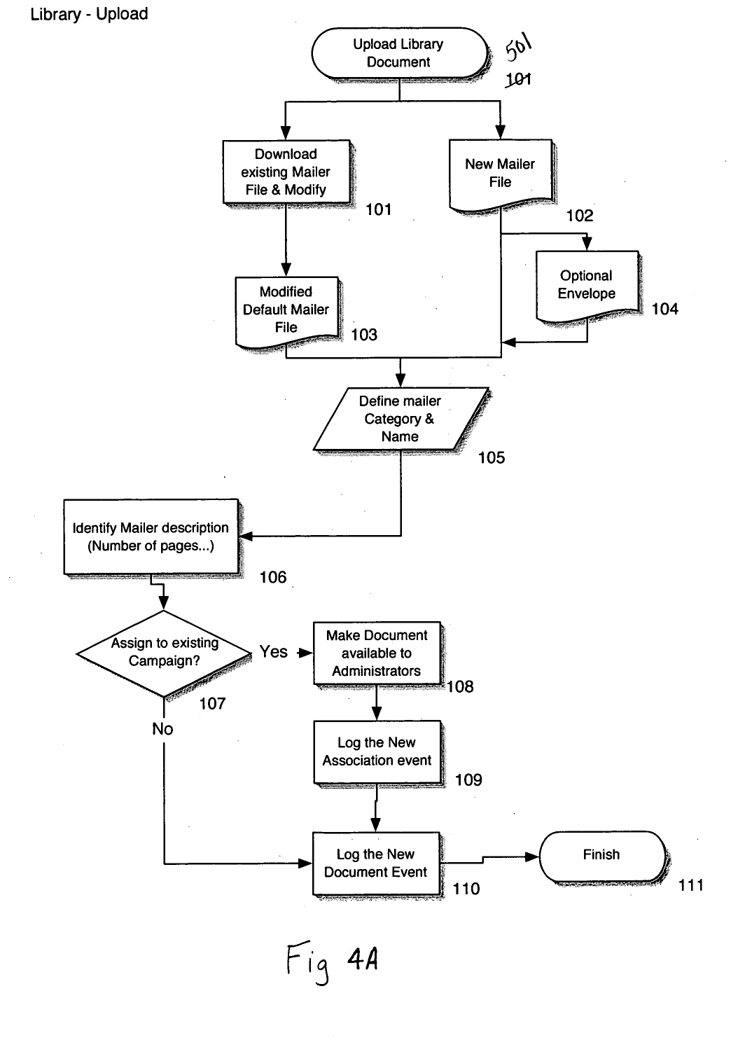

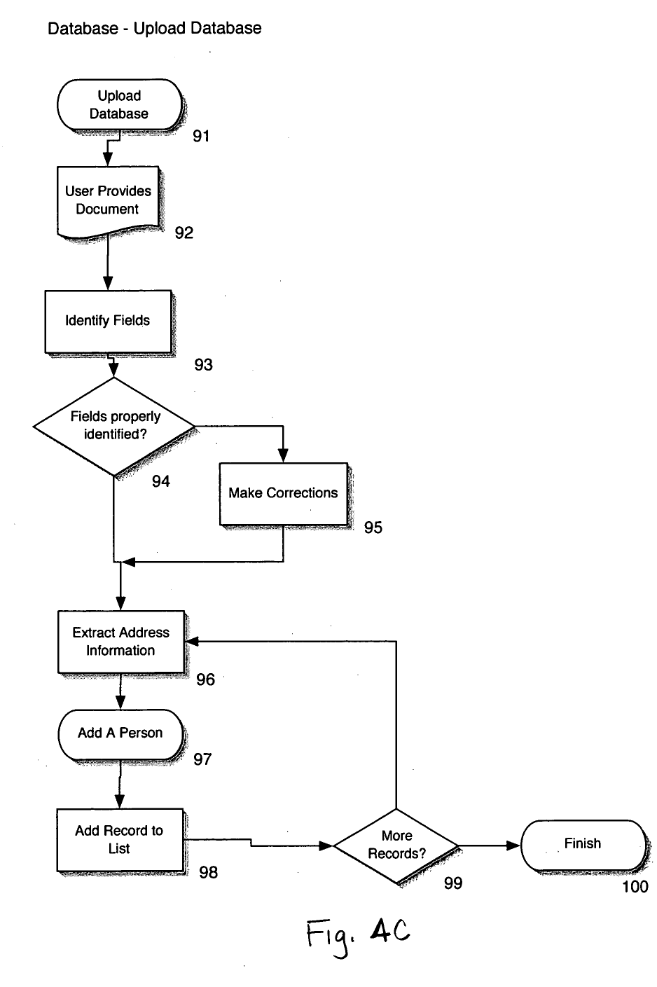

Referring to FIGS. 3A and 3B the import process of any address has an algorithm 77 to create a unique code for an address, based on a proprietary combination of various parts of the address. As each record is added 76, this unique code, called an Address Hash, is computed 77, and the entire database is examined. If the Address Hash is already present 78, the record is not recreated 81. If the Address Hash does not exist, the address record is created 79. Any time a record is added to the database or a record is modified, a hash based duplicate is performed. The hash based algorithm 83 includes the following steps:
1. The address format is normalized. All compass-point directions are changed to single letter abbreviations (“North”->“N”) 84,
2. street types are changed to a common set (“Street”->“ST”, “Str”->“ST”) 85,
3. Apartment and suite identifiers are standardized 86,
4. Stop words are removed (“the”, “of”) 87,
5. Every term besides numeric terms and the two longest terms are removed 88,
6. The remaining terms are concatenated together, and prefixed with a zip code 89,
7. The resulting Hash is stored along with the record, and uniquely indexed by the database 90.

Each address record has an associated history detailing the event log 80. It shows contact history such as dates of last campaigns, or other events, such as callbacks, or when a prospect became a customer. The user may add new events to the history based on a predefined list of common events (such as a callback). The system automatically creates events based on the process, such as the date and time that a mailer was delivered to the address.

Each record has a dedicated field describing if it is a Prospect or a Customer. This field is searchable, when creating a campaign. This field can also be edited.

Each record may be tagged to be excluded from future campaigns of a specific category. The efficiency of the campaign is improved if customers who have already received a particular service are removed from campaigns advertising that same service.

Referring to Fig. A, the system provides a mechanism to upload a user-supplied database 91. The format of the file is a non-proprietary delimited file, with an unconstrained column format. When the system receives a user file 92, it parses the first few lines, in an attempt to intelligently learn the data format 93, and automatically determines how the file is delimited 94. The user confirms 94, 95 the association of columns of data with their data types (“Firstname”, “Zip Code” . . . ) and names the List. Each line in an uploaded database is sequentially, 96, 97, 98 read and broken up into the appropriate fields. If the record is unique, it is added to the database. The record for each uploaded address is automatically added to a List, even if the record previously exists. A list can alternatively come from a third party source such as InfoUSA.

When viewing the entire database, or just a particular list, the user may choose to limit the listing by entering search parameters for any part of the address, including Name and Zip (Postal) Code.

Referring to FIG. 1A a database schema is shown, which reflects the association between the campaign database items and the library items. Particularly shown is the association between a library item 402 and campaign 401, which is further associated with campaign dates 403 selected by the user, the campaign set of contacts 404 and the individual contact addresses 405 and related lists 406 and history 407. The individual contact address or Record (“People” 0 can be associated to multiple lists 406 and multiple history items 407 can be associated to a “People” 405. A “People” 405 can be associated to multiple campaigns 404.

Library

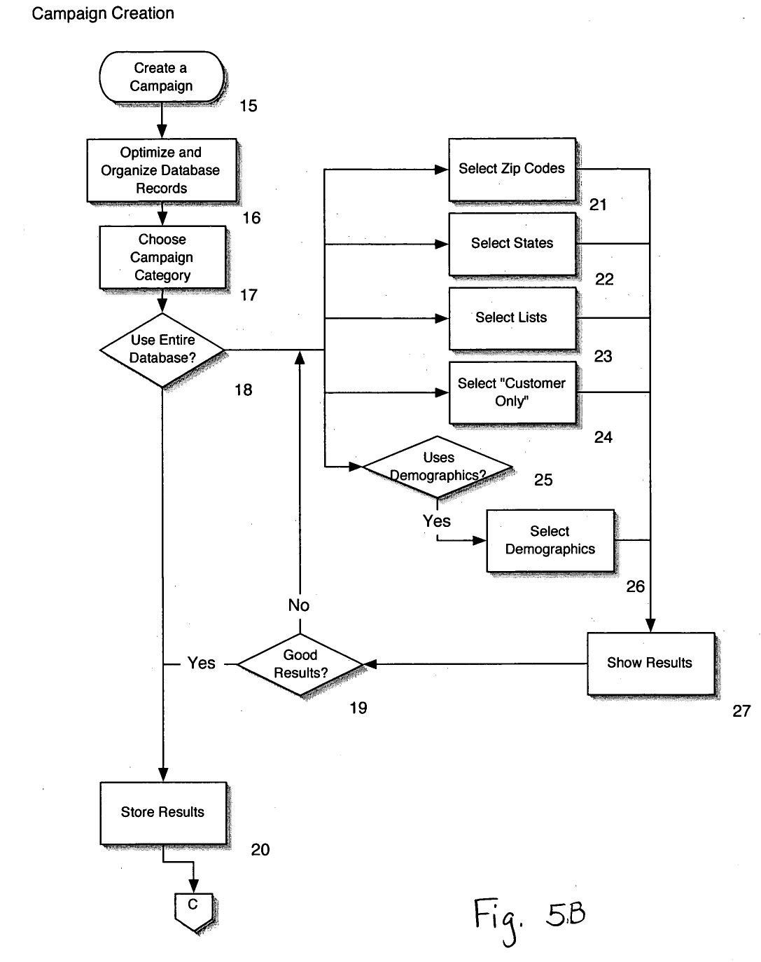

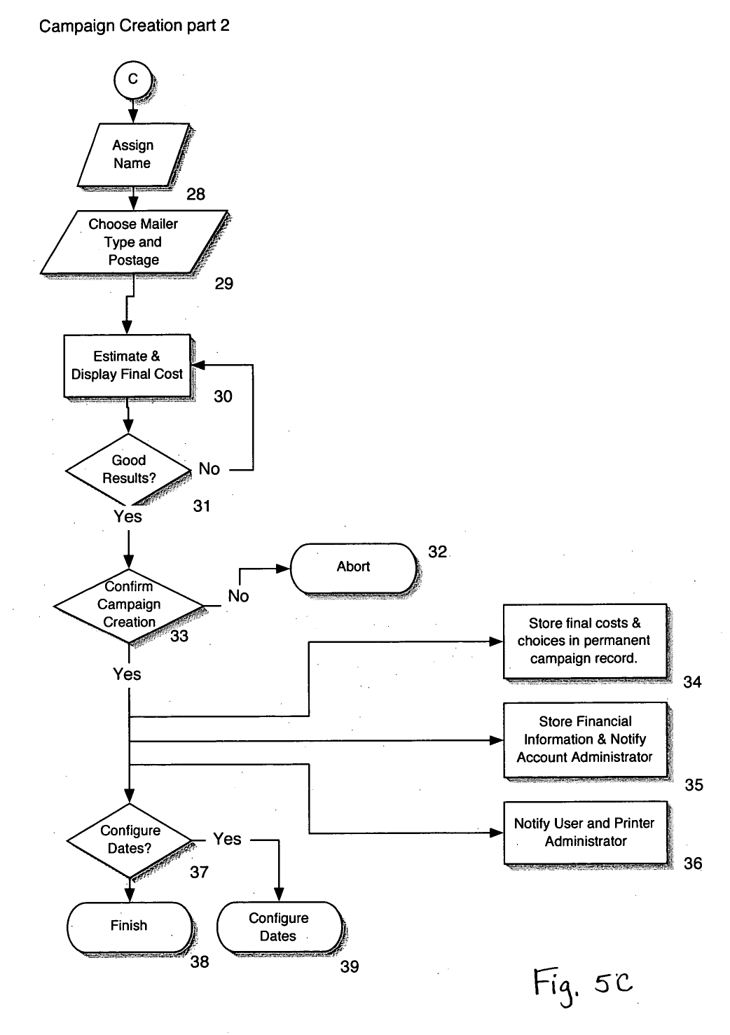

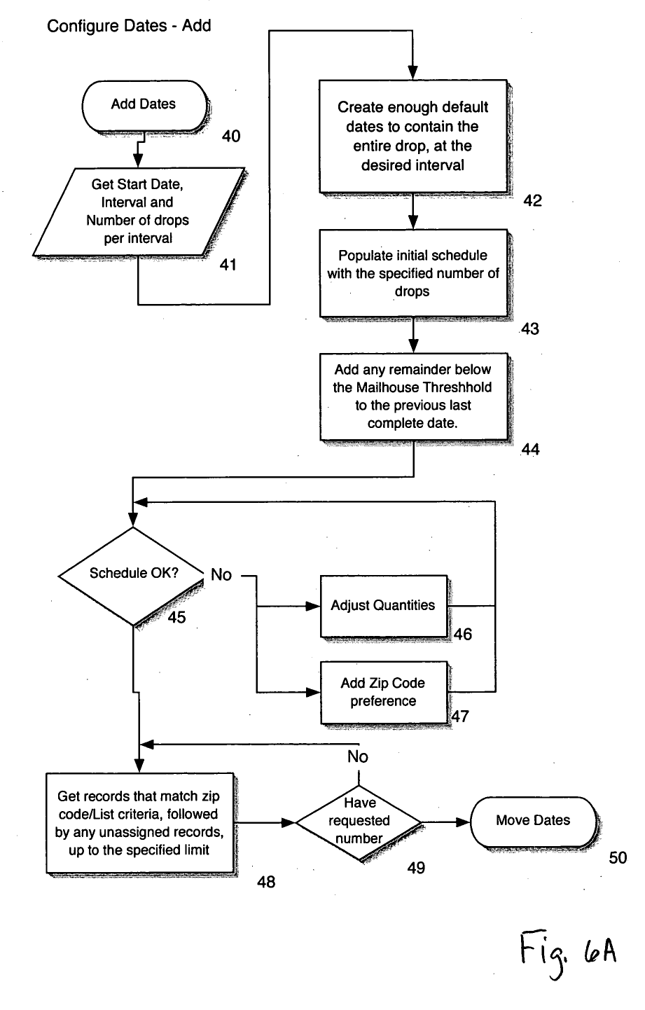

The Library 306, of FIG. 1, is an online collection of mailers. Each mailer is described, and categorized and may be viewed online at any time. The user is presented with a set of predefined mailers, accessible by the user's account type. A user's account type can be based on the user's professional affiliation. A user who is a member of a professional plumbing organization, for example, will be provided with a list of mailers specifically written and targeted to customers who may be in need of plumbing services. Referring to FIG. 5, the mailers can be uploaded 501 by the professional organization in one embodiment or can be provided by others. The predefined mailers for which a given user has access can only be accessed by those users who have an account type that provides authority to access such mailers.

A user is not required to use a predefined mailer. A custom mailer may be locally created and uploaded to the library to create a new mailer file 102 with an optional envelope format 104. A custom mailer is not available for any other user. The format may be any of the common document formats, such as Microsoft Word.

A user may choose to download a predefined mailer, and modify it 101, 103, such as adding a corporate logo. When the user adds this document back to the Library, the association between the custom document and the library item it was based on is preserved.

Each mailer belongs to a category 105, describing the type of mailer it is. Common category examples may include “Home Repair”, “Home Inspection”, or “Furnace Replacement”. A customer who may recently have replaced his furnace may have the record tagged to exclude the customer from any future “Furnace Replacement” campaigns. This improves the efficiency of the campaign, as the user will not have to pay for a mailer to an address where the recipient is known to not require the advertised services.

Each Library item may also include a customized envelope, or the user may choose to provide the envelope file.

Each Library item is identified and coded with all the information necessary 106 for the printer to create the mailer, such as number of pages, letter dimensions and if color printing is required. This set of attributes is also used in estimating prices. Although the individual user may input to the Library, the Library is primarily populated with information and maintained by a Library Administrator. The mailer when uploaded may be assigned to an existing campaign 107 and the document is made available 108 to the Administrators and a log of the new association event is recorded 109. If not the new document event is recorded 110 prior to completion 111.

Campaign Creation

Referring to FIGS. 5A and 5B and 5C a campaign creation flow 15 is shown. Before a campaign may be created, it is up to the user to populate the database, and provide a mailer to the Library if a predefined mailer does not exist. While mailer documents may be added up until the time the campaign is sent to the Printer, the database must be in place before the campaign is created. A basic campaign flow 1 is shown where a campaign can be created 2, a campaign can be modified 3 and tracked 4 prior to completing 5.

The first step in the creation process involves gathering all of the customer's data into a temporary location, where it is physically reordered by zip codes and other key data fields. A database-level record optimization 16 is performed, to further increase the response when the user is performing the search.

Campaign creation requires the user to define which library Category 17 the intended mailer should come from. This initial step ensures that the records tagged to be excluded from certain categories are removed from the subsequent steps of the campaign creation process. The list presented to the user is based on the user's own library items as well as those the user has access to based on the user's account type.

A preliminary query determines the total number of available contact records in the user's database. The user may choose to use the entire record set or search for a portion 18. The user may also specify a target number of mailers. (FIG. 1)

If appropriate, a set of user-defined search parameters is used to obtain the actual set of contact address records. The parameters can limit the final set to those of a particular list 23, a particular set of zip codes 21 (or every record excluding a particular set of zip codes), a set of state abbreviations 22, customers or prospects 24, and if included in the data 25, a set of demographic data 26, such as “age of the house”. Each term entered by the user is used to generate the database query string used to actually obtain a set of records. The system informs the user 27 of the number of matches and allows the user to continue adding or removing terms until satisfaction 19.

Once the number of matches is accepted, the system gathers all the records together, stores the results 20 and relates each address record with the newly created campaign. A record for the new campaign is created, which will eventually contain all the pertinent information about a campaign, such as cost.

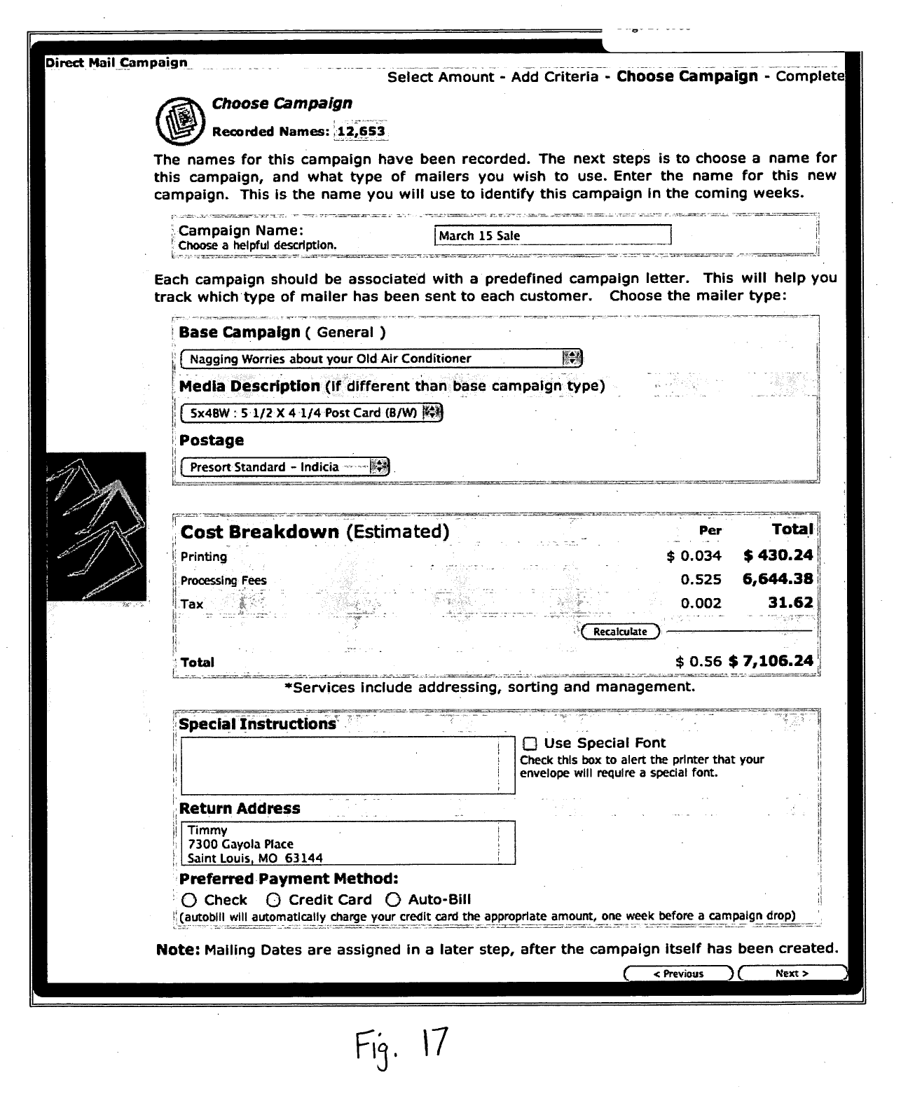

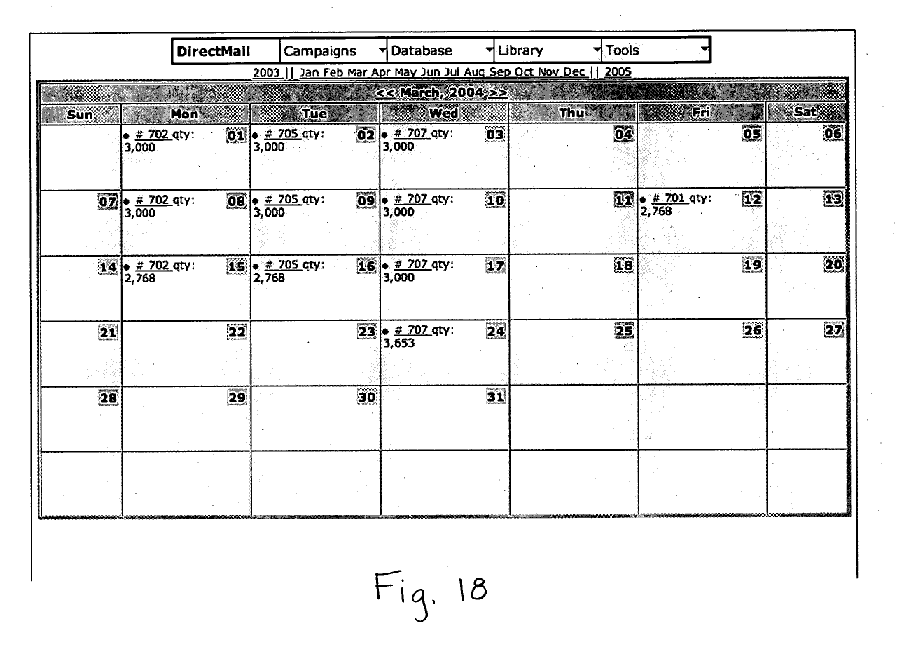

The new campaign is given a name 28 by the user, for easy identification during the life of the campaign. Refer also, to a representative screen shot shown in FIG. 17. The user also supplies additional information, such as mailer type and postage type 29 (i.e. presort standard versus first class), and chooses a document from the Library. The system uses this information, as well as the campaign count (the number of records now associated with the campaign) to come up with an estimated total cost 30 and a breakdown of printing costs, tax, and other fees. Costs are estimated using an Administrator-defined Quantity-Cost map (discussed later).

If good results are achieved 31, the user confirms all of the information 33, the campaign record's temporary status is removed, the costs involved are logged 34, and a campaign history is started. A campaign history will contain all the information pertaining to the development and progress of a campaign. The initial entry is simply the date and time of creation, but will eventually include other events such as when a mailer document is added. The Account Administrator, user, and Printer Administrator are notified 35 and 36. The user has the option to configure date now 37, 39 or complete the dates later 37, 38.

An e-mail is sent to both the user and the Administrator in charge of handling the aspects of the actual mailing. The user's email contains all the basic information, as well as hyperlinks for online payment. The Administrator's email contains the additional information necessary to begin the printing and accounting processes.

Campaign Management

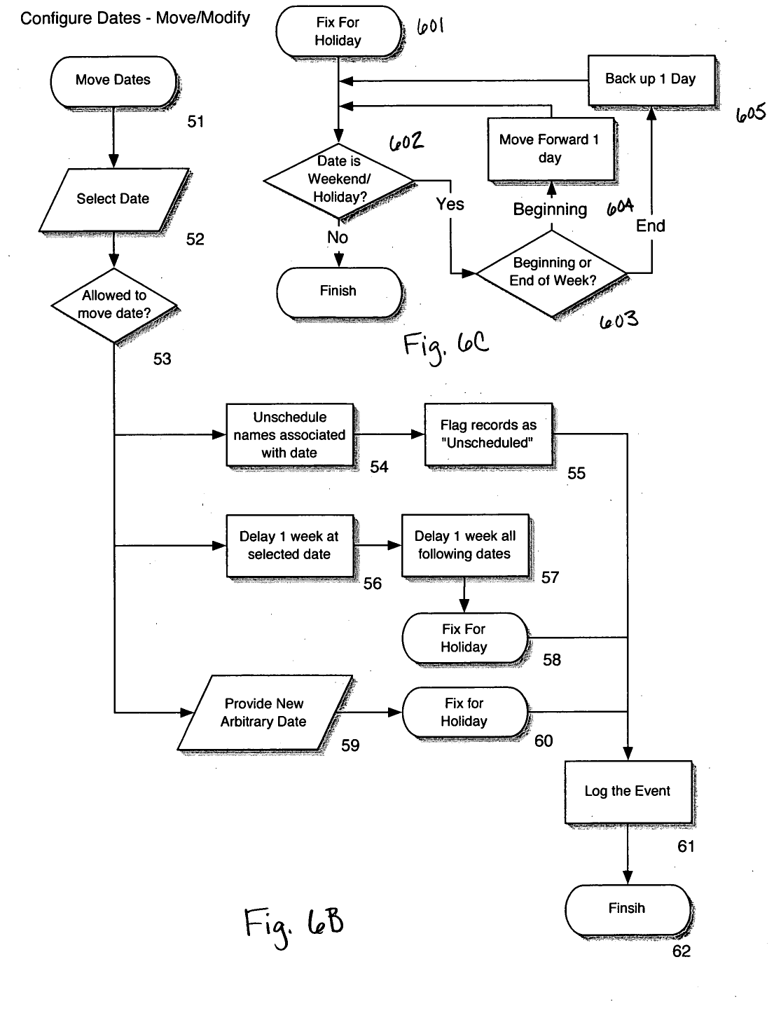

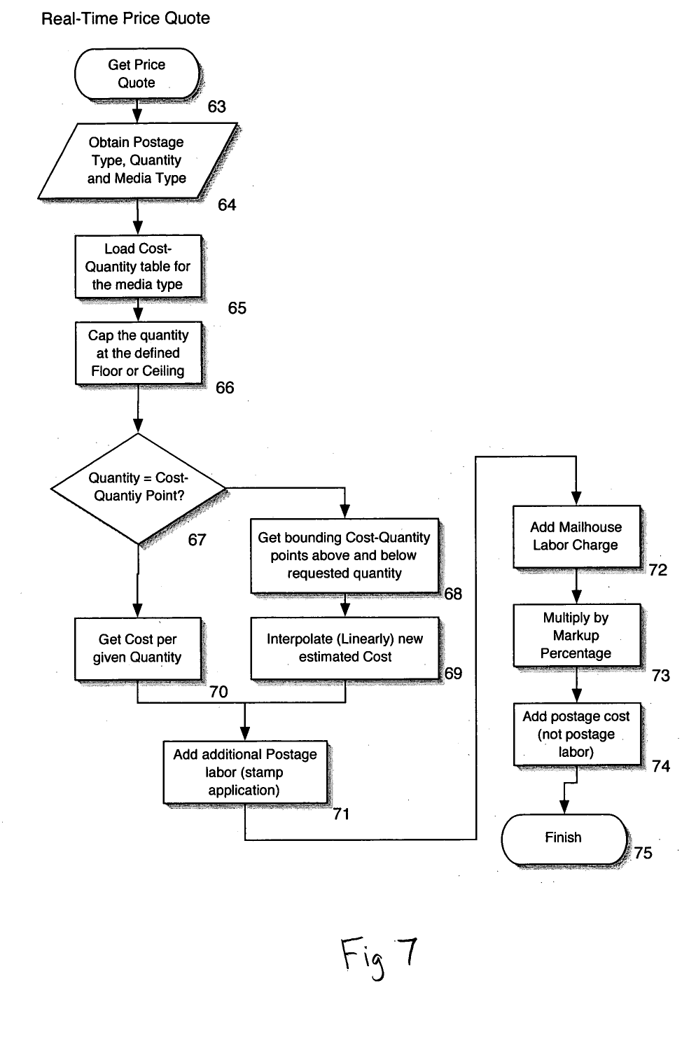

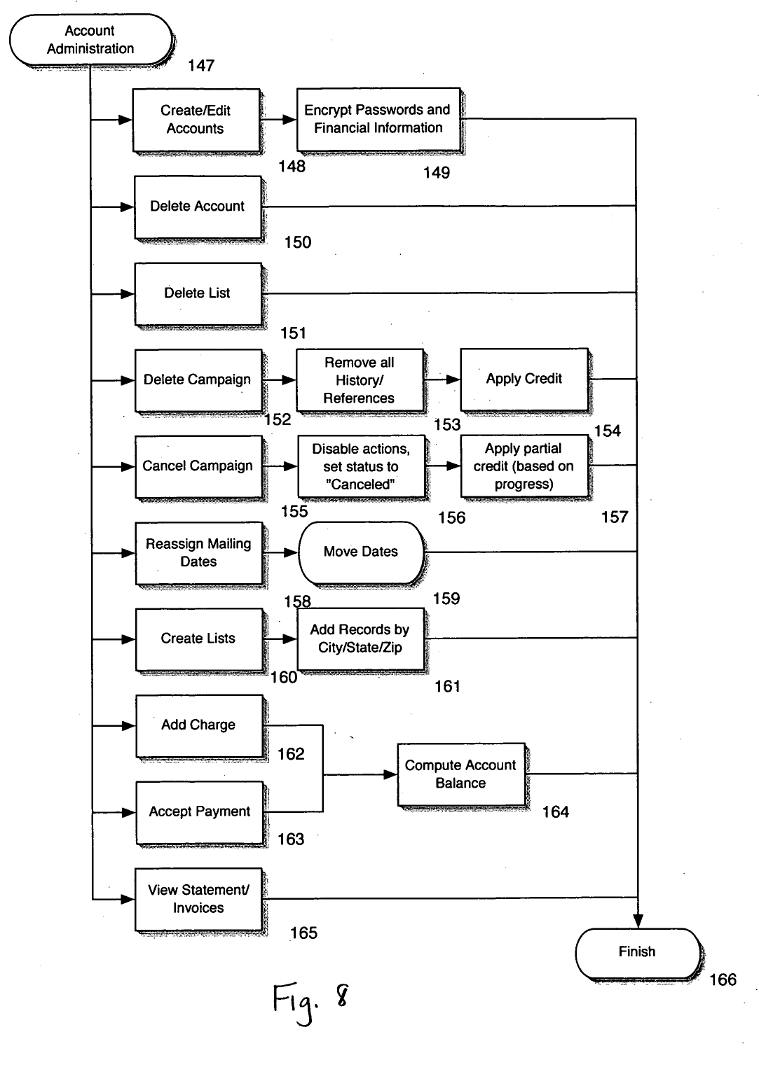

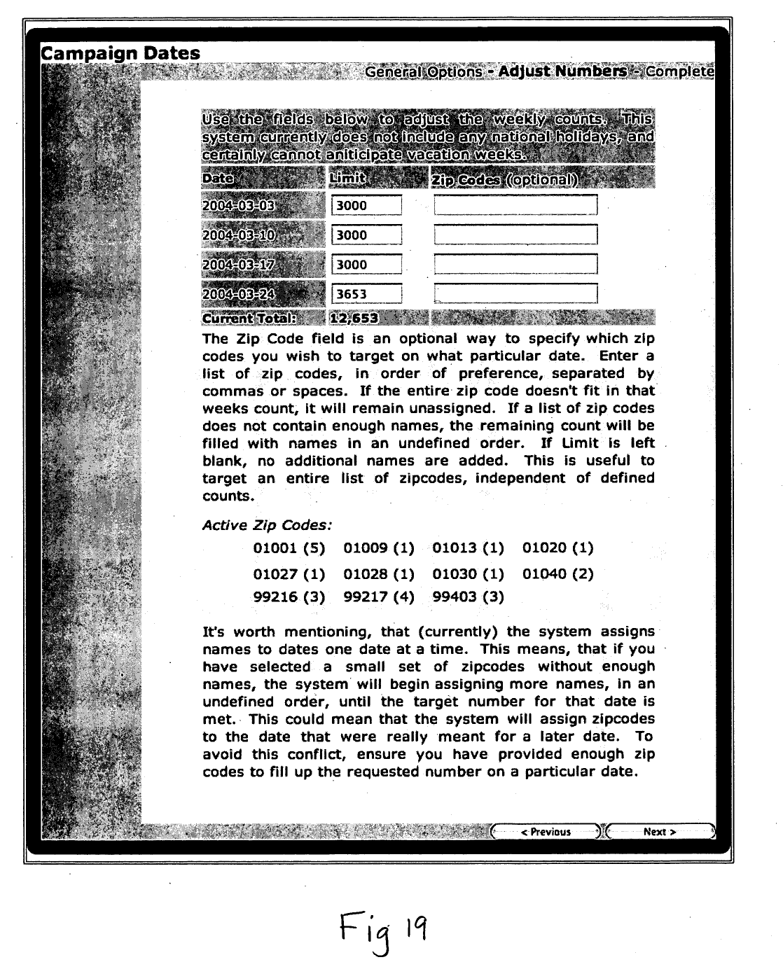

Referring to FIGS. 6A, 6B and 6C, if no dates exist for a campaign, the user must create the initial schedule 40. To generate the initial drop schedule, the user provides the starting date, the weekly count, and the interval (1 week, 2 week, monthly or quarterly) 41, 42, 43, 44. The user has the ability to review the drop schedule 45. Refer also, to a representative screen shot shown in FIG. 18.

Based on this information, the system chooses the initial schedule of dates and counts. If the system lands on a day that is a holiday or weekend an adjustment is made 601, 602 it advances toward the middle of the week until a non-holiday date is found 603, 604, 605. If the count of the last week falls below the Mail House-imposed limit of 1000 pieces quantities can be adjusted 46, the count is added to the prior drop. The user validates the dates and counts, and specifies how the system assigns actual records to the dates.

If the user provides a list of zip codes 47, the system first chooses names from the provided zip codes. If the number of names in the zip code list exceeds the weekly limit, the list is truncated randomly. If the number of names in the zip code list is less than the specified limit, the remaining spaces are filled with random names from the database.

In addition to zip codes, the user may also specify which Lists to choose the names from. Each of these options allow the user to create campaigns with geographically targeted drops, to avoid a single week generating potential leads all over the coverage area.

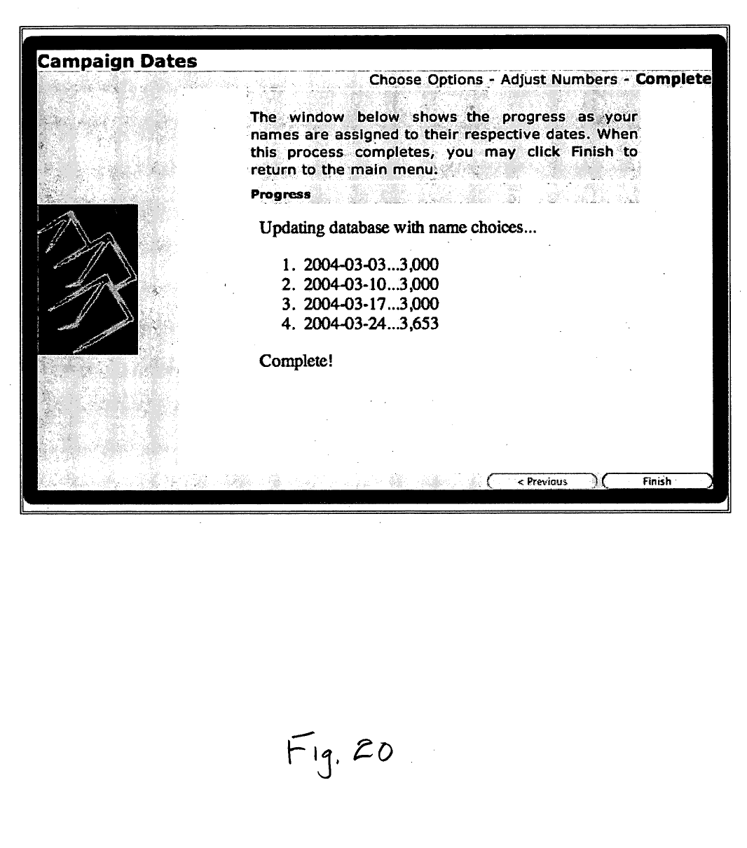

The system takes the user information and sequentially assigns each record to the specified date, using the list or zip code information provided. If a particular set of records for the given zip code (or list) is exhausted before the desired weekly count is reached, the system fills the remainder with surrounding zip codes, in attempt to preserve the geographic organization, from the pool of unscheduled names. If the particular set of records for a given zip code (or list) is greater than the desired weekly count, the system returns the remainder back to the unscheduled pool of names, for use in a later date assignment. Progress is displayed to the user, and the assignment is taking place, and the action is logged in the campaign's history. Refer also, to FIGS. 19 and 20 for representative screen shots.

Since campaigns may be spread out across a large amount of time, it may be necessary to adjust future drop dates 51 (the date when a set of address mailers is delivered to the post office), even after the initial dates have passed. If a scheduled drop date is not within the Mail House-imposed window of time 52, 53 (usually 24 hours before the drop), the user may reassign the date.

A date may be removed entirely, sending the associated records back into the pool of unscheduled names 54, 55. The date may be delayed by one week 56, which effectively pushes all subsequent dates back a week as well 57. A date may be arbitrarily reassigned 59. In this case, no following dates are automatically accepted. If the date is reassigned to another existing date, the names in those dates are combined into a single drop.

In every case where a new date is selected, the system ensures that the selected date is not a US National Holiday or a weekend 58, 60. If this happens to be the case, it is automatically reassigned to the nearest non-holiday date. The date change is ultimately logged as an event 61 prior to Completion 62.

Every document associated with a campaign may be viewed online. If the user has uploaded a document to the Library and associated it with a campaign, the upload event is recorded in the campaigns' history. If the Printer Administrator has uploaded the Final Proof (the uneditable, platform-independent version of the mailer, used for printing), it is viewable. The Printer Administrator's role is to convert what the user has selected, or provided for the campaign, and convert it to a final, printable format. After the Final Proof has been created, it is uploaded and attached to the campaign, and the Printer Administrator begins physically printing the mailers.

For each campaign, a detailed log of all financial transactions associated with it is maintained. The total cost of a campaign is defined as the raw campaign cost, including markups, additional charges (such as extra postage), discounts, and credit from a previous order applied to the current campaign.

The total amount paid on a particular campaign is recorded, along with the amount and date of each payment. The current minimum payment for a given week is calculated by determining the relative cost of the current week, based on the relative size of the drop (number of names). The minimum payment is the current week's cost, plus the sum of all the previous weeks cost, minus the current total amount paid.

Users receive a “Minimum Payment” email one week before the scheduled drop if the minimum payment is greater than zero. The user is provided with a link to a secure payment area, which also contains printable invoices and monthly statements. If the user had selected Auto Payment when creating the campaign, the Minimum Payment amount is automatically charged to the user's credit card one week prior to drop date.

If a particular scheduled drop date for a campaign has already occurred, the official USPS postal statement (3602) of the transaction is electronically scanned by the Mail House Administrator, and associated with the appropriate campaign drop date. The document is viewable by the user at any time after the drop to the post office has occurred.

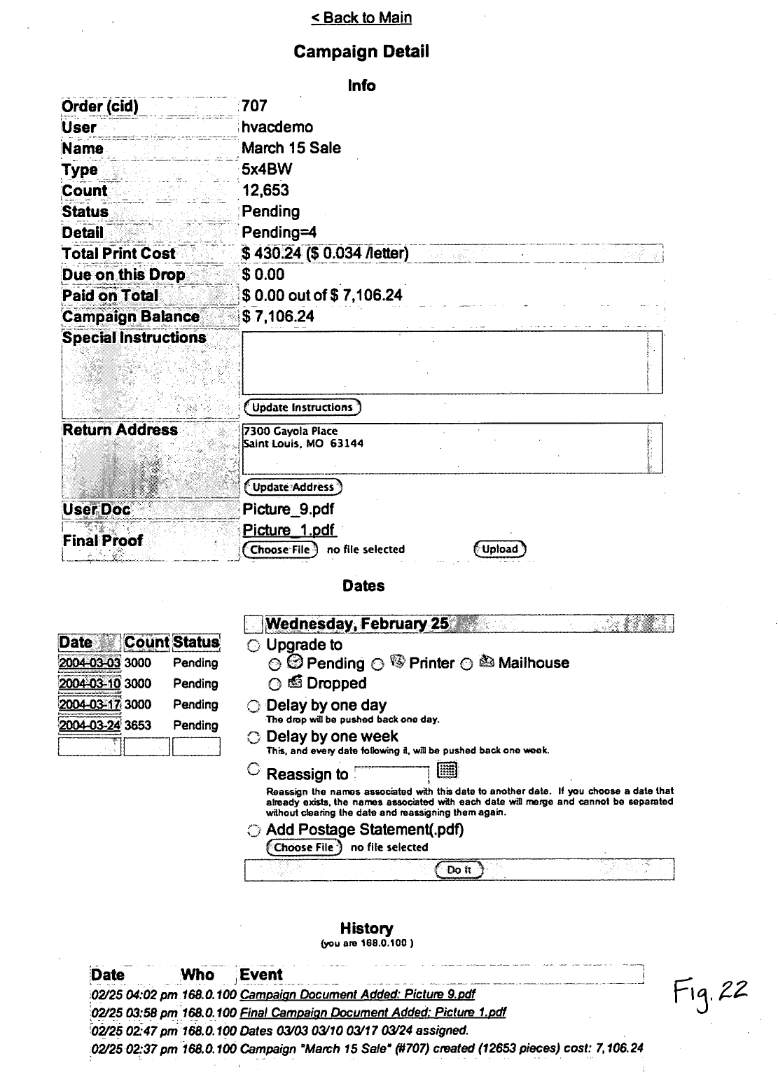

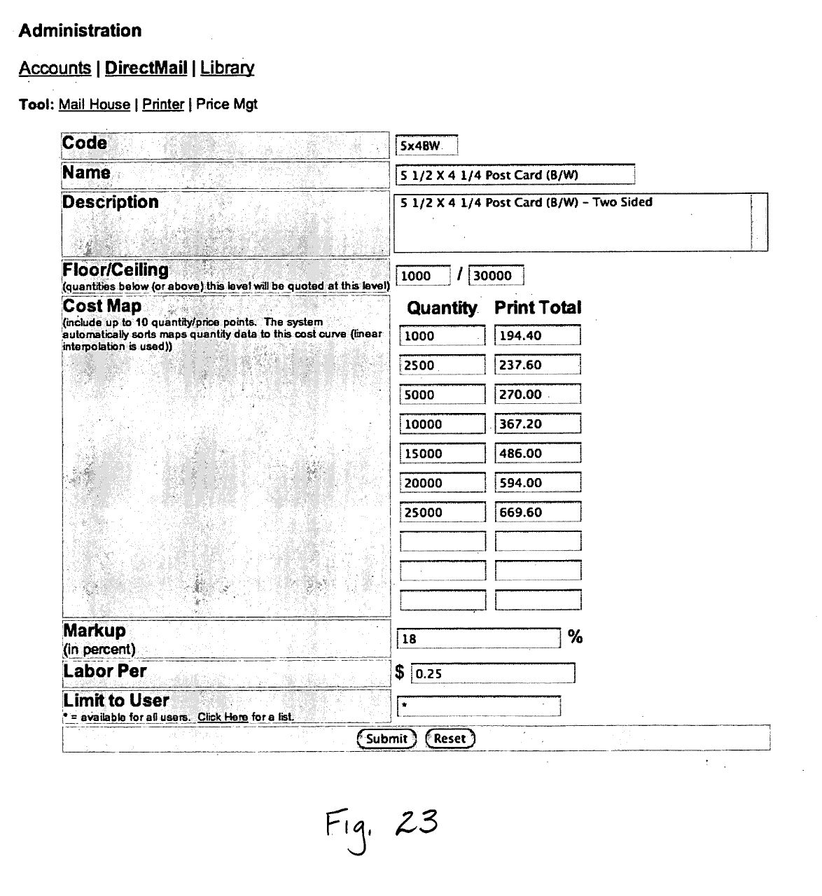

Referring to FIGS. 21 and 22 for representative screen shots, as a campaign progresses from ordering to completion, real-time status tracking is available to the user. Each date associated with a campaign has 4 major steps. Pending indicates that a campaign has just been created, and no activity has yet occurred. When the Printer Administrator receives (via the Printer Administration area, discussed later) approval of a mailer document (final proof), the status of the campaign is promoted to Printer indicating that printing has begun. After printing is completed, the media is delivered to the Mail House. The Mail House Administrator receives the media and promotes the campaign to Mail House, indicating to the user that printing is complete and added to inventory, and the campaign is being prepared for mailing. Once the Mail House has completed all the tasks necessary for mailing (addressing, enveloping, applying postage, sorting) and drops them at the Post Office, the Mail House Administrator marks the campaign date as Dropped, indicating to the user that all the records in the database scheduled for a particular date have been mailed. When a campaign date has been dropped, it is out of the system. Occasionally, a campaign can be Cancelled, which indicates that a user has, for example, failed to make payments, or wishes to end a campaign prior to completion.

Tools

There is always a Price Quote feature 63 available to the user, which provides prices, based on the postage, the quantity, and the type of the media 64. The raw prices are entered by the Account Administrator, based on cost data provided by the Printer and Mail House, into a Quantity-Cost table 65. The quantity is capped at a defined floor and ceiling 66. If the quantity requested exactly matches a quantity in the table, the associated cost is used. If the quantity is not found, a linear-interpolation algorithm estimates the cost, with quantities capped at each extreme by Account Administrator-supplied values 67, 68, 69, 70. Refer to FIG. 23 for a representative screen shot.

If the supplied postage type is a stamp or other type where an additional postage application charge is incurred, that cost is added to the current cost-per 71. The Mail House Administrator-supplied labor-per charge is added to the current cost-per 72. The cost-per is multiplied by the Account Administer-supplied markup percentage 73. The postage costs (excluding postage labor) is added to get the final cost-per 74, completing the real-time price quote 75.

There is a set of graphs available to the user, which displays information from the database, such as the number of records in each zip code, city or state. The view may be limited to a specific campaign, and even a specific campaign date, useful in planning the expected call rate for a geographic region.

A Campaign Delivery Report is available which contains a printable view of the names, zip codes and phone numbers for a campaign, optionally limited to a particular campaign date. This allows users to perform callbacks to their customers after the system reports that they have received the mailer.

A Calendar is available, showing a quick overview of when drop dates are scheduled. Refer back to FIG. 18 for a representative screen shot. The view allows the user to jump to any month or year.

The system can provide a list of records with obviously incomplete records. Of primary importance are those records with missing or short zip codes, missing street numbers, missing first and last names or improperly formatted P.O. Boxes.

### Description of Administrative Modules and Processes

Account Administration

Referring to FIG. 8, the Account Administrator functional user interface portion of the application 147 is responsible for maintaining the back end of the system. An Account Administrator's responsibilities include managing User accounts, handling accounting, and coordinating with the Printer and Mail House. The Account Administrator function of the application provides the functionality and user interface to perform these responsibilities. In a sense, this Administrator is the primary Administrator and is usually the entity actually profiting by offering the present invention.

This Administrator function has a set of privileged tools that allow for managing user accounts 148, and managing a particular user. All sensitive information (i.e. password, credit information) is encrypted 149 by the application to protect the data. The Account Administrator function allows the Account Administrator to update any of the information for any user, or delete 150 the user entirely.

The Administrator has an additional set of tools that the user does not have. An administrator can delete any campaign 152, even if it is in progress, which removes any record of it ever existing 153, 154. A campaign may also be canceled 155, which is useful if the user has failed to make payments or other special circumstances. When a campaign is canceled, the cost of the remaining postage is refunded to the user's account 157, by default.

The Administrator may delete a user's List 151, which the user cannot do, as deleting a list that is already being used may corrupt the history or current state of any campaigns. There are situations where a List should be deleted, and the Administrator will have knowledge of such events, which the user may not. When a List is deleted, the system can, optionally, identify each address record, which is no longer associated with any list, and remove them from the system.

The Administrator may utilize the functional interface to assign any dates 158, 159 from any current campaign without any of the restrictions imposed by the system on the user, such as the 24-hour window. As with Lists, the Administrator is usually in a more knowledgeable position, usually dealing with the Mail House directly, and so can make the informed decision on if it is valid to move a date within the Mail House's window. Even the Administrator is not allowed to move dates to a US National Holiday.

The Administrator is able to do simple zip code or city searches on the user's data and create aggregate Lists based on these simple searches 160, 161. The Administrator cannot add address records to a List in such a way that duplicates would be created within the List.

The Administrator can also export (“dump”) the entire user's database, which is an option not readily available to the user, to help prevent the user from taking the database to a competitor.

The Administrator function also provides tools for managing the financials of the users. In addition to the automated accounting that the system performs (such as charging the user whenever a new campaign is created), the Administrator function can create new Charges 162 (for things such as additional postage), Credit (reducing the payable balance on a campaign), Discount (which affects the initial cost of a campaign), and Payment 163 (both by check or credit card). Each financial transaction is logged in the database along with the cost, and the user's account balance is updated to reflect the new amounts 164.

The Administrator may quickly jump to, and print, any user's invoice or statement 165. This becomes useful when the user calls the administrator to discuss a billing issue.

The Account Administrator function equips the Administrator with tools for providing the Quantity-Cost mapping of each mailer type offered. A mailer type is a unique set of descriptors of a mailer, such as the page's dimensions and color.

The Administrator provides a short, meaningful code, a short, human readable description of the mailer type, a longer, more detailed description, the user's markup (in percentage), the labor cost per item, excluding postage labor and optionally a list of users this mailer should be made available to. This allows for one-time special prices on a unique order.

The Administrator function also defines the Quantity-Cost map. This map is used to generate a simple curve to map any given quantity to a given cost. The curve allows for larger costs at lower volumes. If the map has only two quantity-cost points, the resulting curve is a linear line. If more points are provided, tighter control and prediction of the resulting cost may be obtained.

The Q-C Map also allows for a floor and ceiling when estimating costs. If the curve is too steep at the low end, and the user entered an exceptionally low number, the curve could dip below zero at that quantity, resulting in an unacceptable negative cost. With a floor in place, the lower quantities are computed at the Floor value, ensuring the cost will remain in a reasonable part of the Q-C curve. Ceilings work the same way, and avoid rapidly increasing costs above the define curve.

An Administrator-specific price quote system allows for fast debugging of the Quantity-Cost map. The Administrator version includes a more detailed breakdown of the costs.

An overview of all mailer types is available. It contains the code and description for total cost of 1000, 5000 and 10000 pieces.

Database Administrator

Referring to FIG. 9, the Database Administrator is responsible for managing the contact address records in the database and utilizes the Database Administrator functional user interface of the present application 135. This administrator is usually associated with an external data provider (Currently supporting InfoUSA). When a user manually requests to purchase new address records, this administrator function receives the request, which contains contact information and a description of the demographic and geographic set of addresses the user is interested in.

Once the external data source has provided the records, the Database Administrator can utilize the Database Administrator function to add the records to the user's database 136. This data is in a predefined format, unlike the open format available to the user. The Administrator can specify a new name for the List, and who to send an automated e-mail notification to, once the data is imported. The Administrator may also remove an entire List 137 from a user's library, or export (“Dump”) an entire list. The Database Administration function also allows exporting of database to a database file 138, 139.

Library Administrator

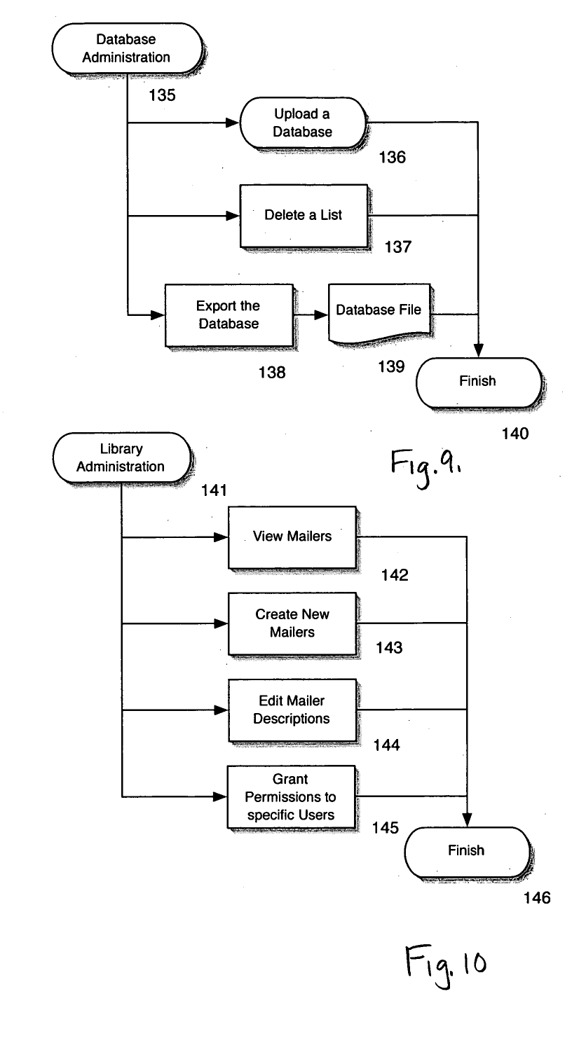

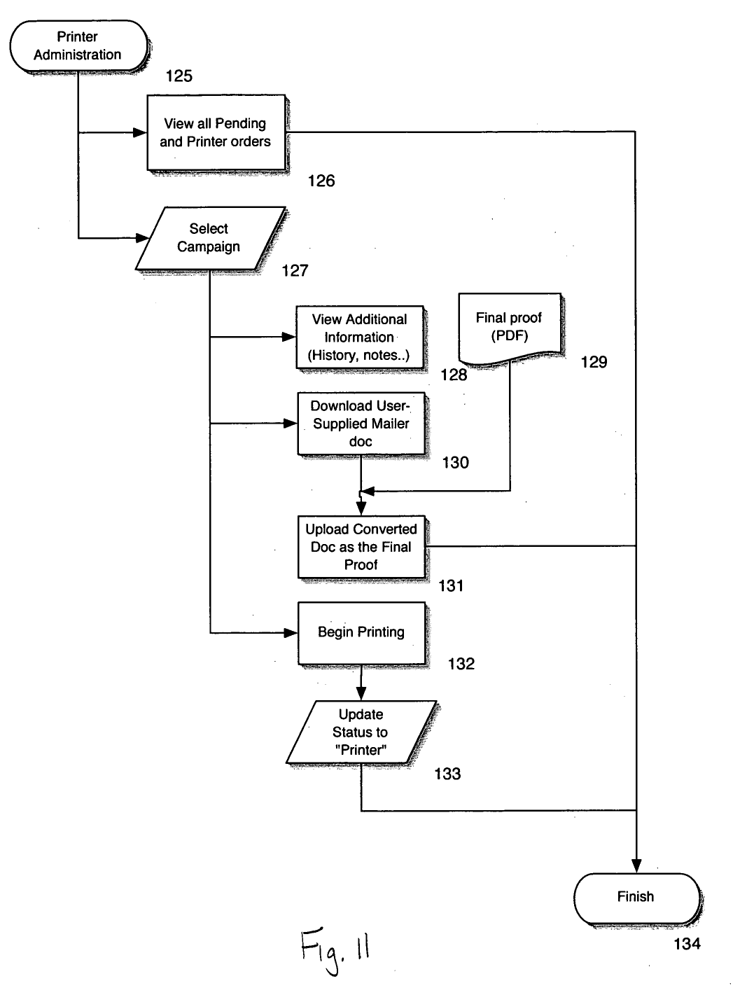

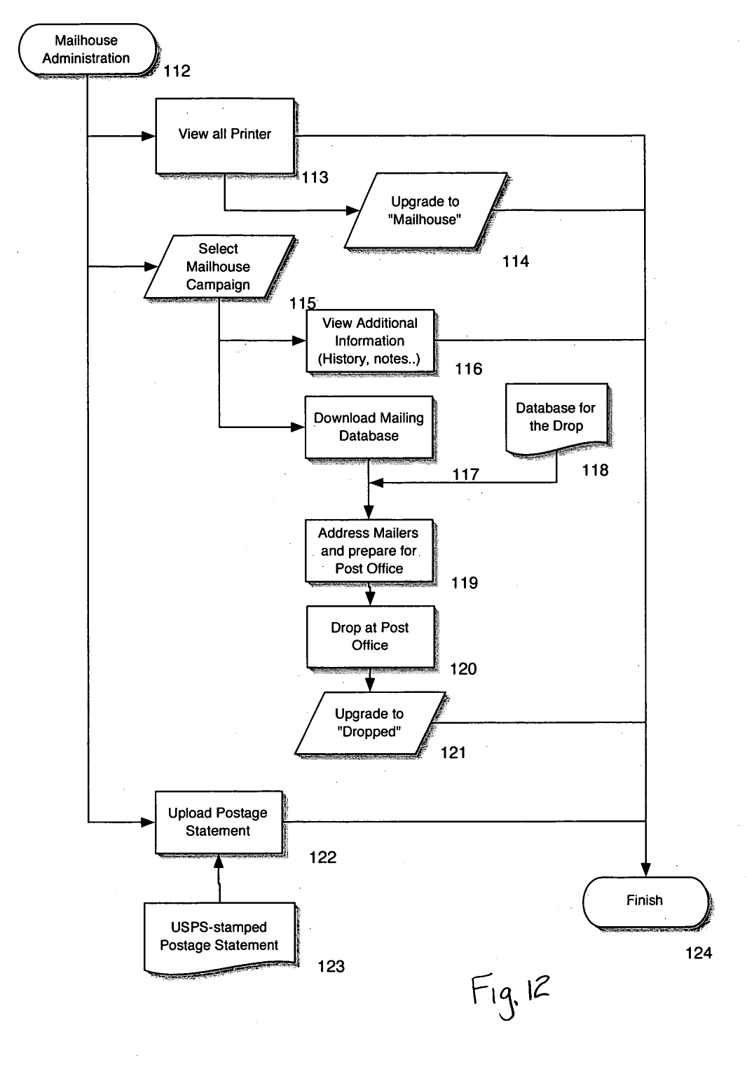

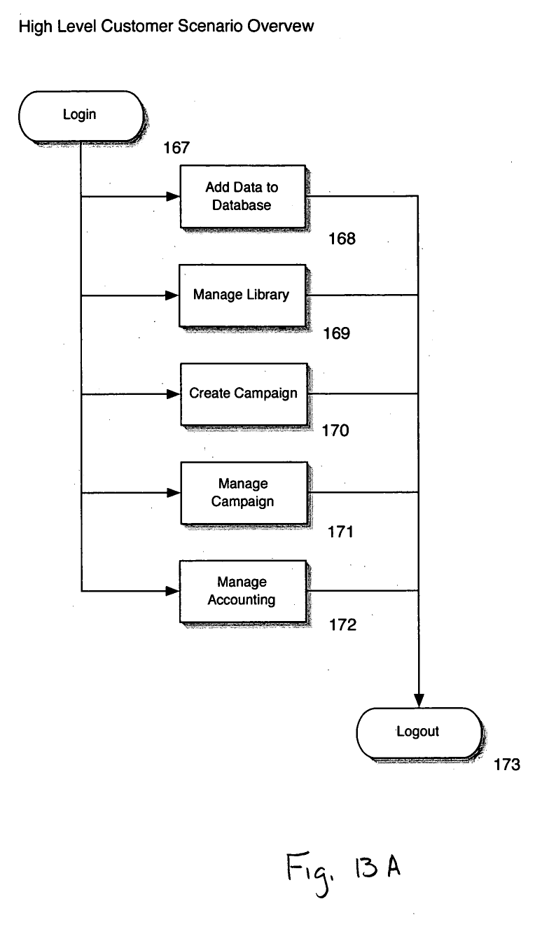

Referring to FIG. 10, the Library Administrator is tasked with creating and maintaining the predefined set of mailers that a user sees when viewing the Library and utilizes the Library Administration functional user interface 141 of the present application to perform the task. As described, the Library contains a collection of mailers grouped and categorized by the industry of which the user is a member. The Library Administrator is usually one well educated in the ways of direct marketing in the user's industry. The Library Administrator could be a trade organization.

Since the user may not be skilled in marketing, it is hoped that the Administrator will provide a researched and tested set of marketing material to the Library. This benefits both the user, allowing for better responses, and the providers of this application, as such well engineered documents become a significant service to the user. As stated, the user may modify any of the ones provided by the administrator, or upload his own. The Library Administrator can utilize the Library Administrator user interface function to input the information into the Library.

The Administrator may view all default library pieces 142, edit any of the ones online 144, or create new ones 143.

The Administrator may also grant access to specific users 145 or the entire system. In some cases, a user may have attended a special seminar, or paid a special fee, to be privileged to “advanced” mailers. This function allows the administrator to provide incentives.

Printer Administrator

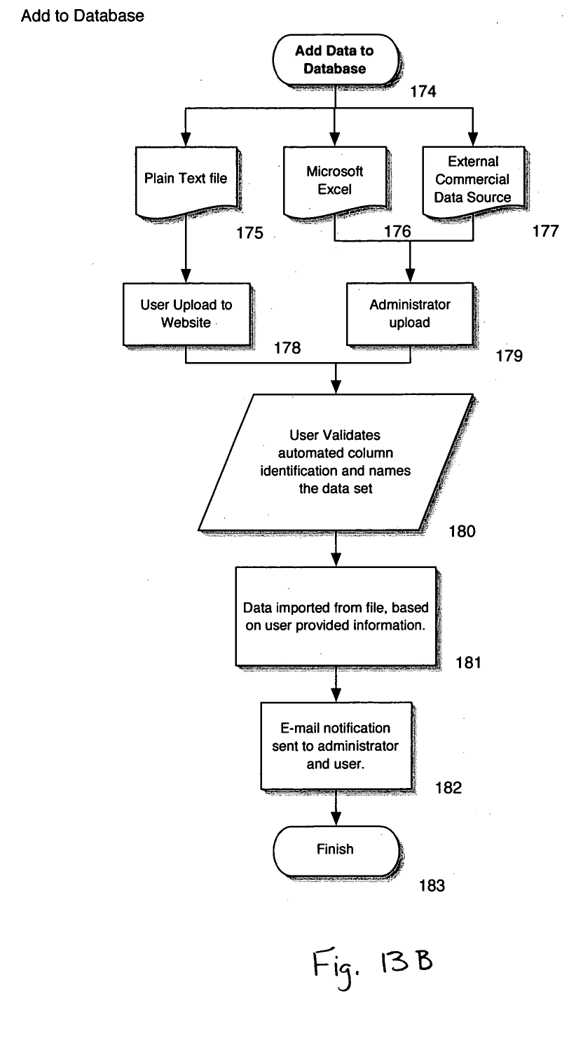

Referring to FIG. 11, the Printer Administrator's role is to create the physical mailers that will eventually be sent to each address in the user's campaign list. The Printer Administrator utilizes the Printer Administrator functional user interface 125 of the present application to perform this task. The printer is presented with a list of all campaigns in the Pending or Printer state 126. The list contains the order date, the user identification and the order number. The administrator may adjust the view to any starting date and view any number of day's worth of campaigns.

The Administrator may view details 128 about each campaign in his list, a view shared by all administrators. These abilities include adjusting the states of particular campaign dates, or reassigning dates (without constraints) to other dates.

This Administrator is most interested in the User Doc, uploaded or selected by the user and can download user supplied mailer document 130. This is a format-independent document containing the intended mailer, which the Administrator, utilizing the functional user interface, will download, proofread and convert to a PDF, a standard, platform-independent format, suitable for proofing and printing. This document is uploaded as the Final Proof, and becomes available to the customer 130, 131.

When the Printer Administrator function begins printing 132 a campaign, the Status is updated to Printer 133, which indicates to the user that the campaign's final proof has been received and is in the process of being printed. At this point, the campaign is considered “In-Work”, and can no longer be deleted by the user, only by the Account Administrator. When the Printer finishes printing the mailers for the campaign, they are physically delivered to the Mail House.

Mail House Administrator

The Mail House Administrator is presented with a similar view 113 to the Printer Administrator, with the additional lists of impending campaign drop dates. The Administrator can utilize the Mail House Administrator functional user interface 112 so that he can set date ranges, as the Printer Administrator can, but can also limit the list to particular users or particular order numbers.

This Administrator is first presented with a list of all campaigns marked as “Printer”. When the Administrator receives the mailers from the Printer, they are marked as Received, and the status of all the dates associated with a campaign are promoted to Mail House. This event is logged in the campaign's history and lets the user know that the campaign the printing is complete and is in inventory.

When a campaign has been promoted to Mail House, it is no longer displayed as a single entity, but rather a collection of scheduled drop dates. Each scheduled drop date provides pertinent details to the Mail House Administrator, such as the quantity selected for that particular drop.

The Administrator may obtain a plain-text file containing the names and addresses of every person scheduled for the drop by the user. The administrator's role at this point is to merge the database with the physical mailers utilizing the user interface, and prepare each mailer for delivery by applying postage, addressing, folding, correlating, and inserting. When the newly addressed mailers are prepared for mailing, they are “dropped” at the Post Office. The Administrator now marks the campaign date as Dropped.

Once a date has been Dropped, it is considered complete, and out of the control of the system. The user can no longer modify dates or any information related to the date.

The Mail House is instructed to take note of the “Not Paid” flag, used to indicate if a user has failed to pay for that particular drop.

After the mailers have been delivered and processed by the Post Office, the Post Office supplies an official, stamped Postage Statement (3602). The Mail House Administrator scans this postage statement into an electronic format, uploads it, and associates it with the campaign (FIG. 18). The uploaded Postage Statement is immediately viewable by the user and provides legal verification that any particular drop was completed.

When all dates of a campaign have been Dropped, the campaign itself is labeled Complete, and no further activity is performed on it, with the exception of any lingering Postage Statement uploads.

Miscellaneous Features

Independent of the application process, Direct Mail has other noteworthy features. In many cases, the customer is sent an email detailing important events, such as when a payment is due, or when a campaign was created.

The application is also “skinable”, which means the look of Virtual Mail House may be tailored to suit the specific look of a new company, interested in offering online Direct Mail services to its customers.

The application logs all major events, such as payments, campaign creations and database importing. This creates a “paper trail” of sorts, and also allows VDH to gauge the popularity of the various aspects of the program. This information is useful when determining which features to enhance.

Day in the Life of a Typical User Scenario

The following section details a common “Day in the Life” of a typical user utilizing the present system, beginning from a new account, through completion of a campaign. The features of the present system described herein are not necessarily a complete, functional description, but rather are intended to show use, and application flow.

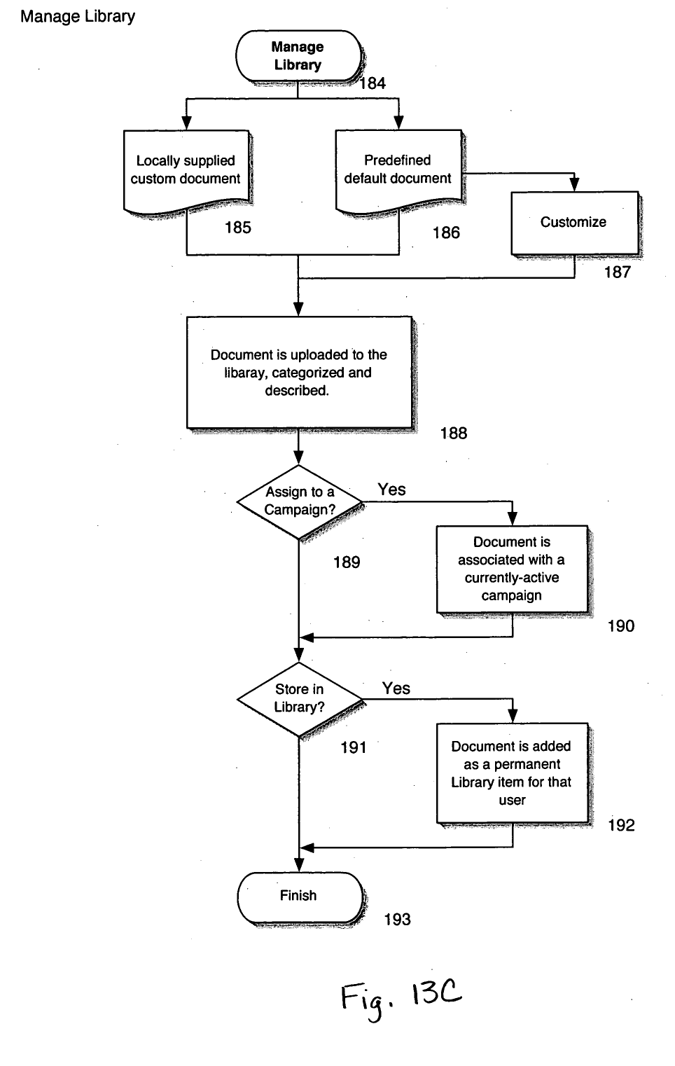

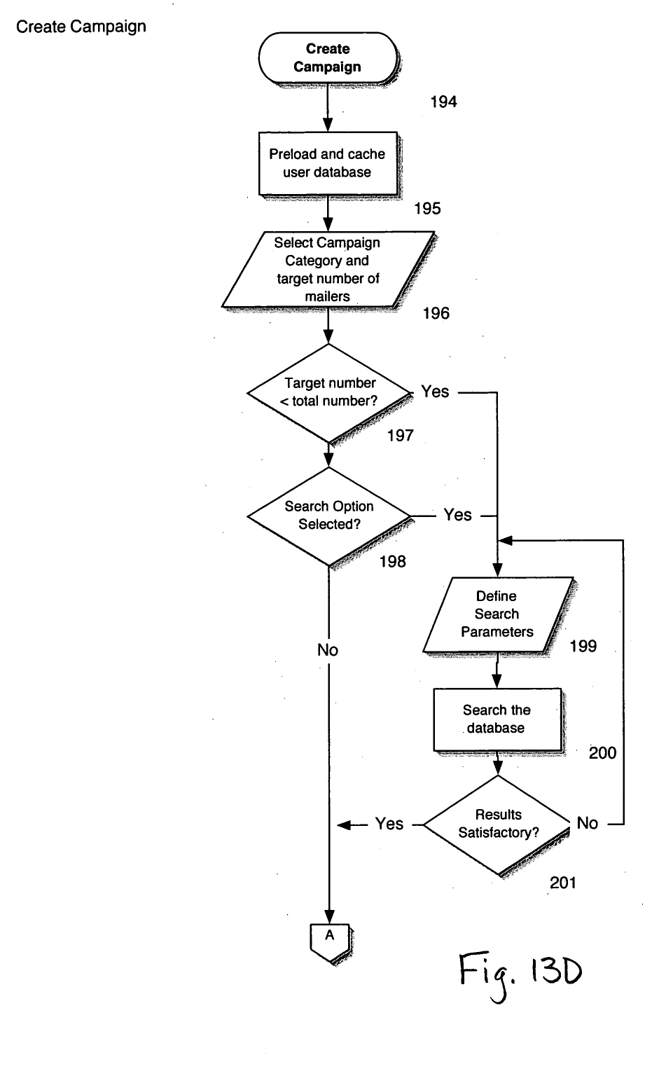

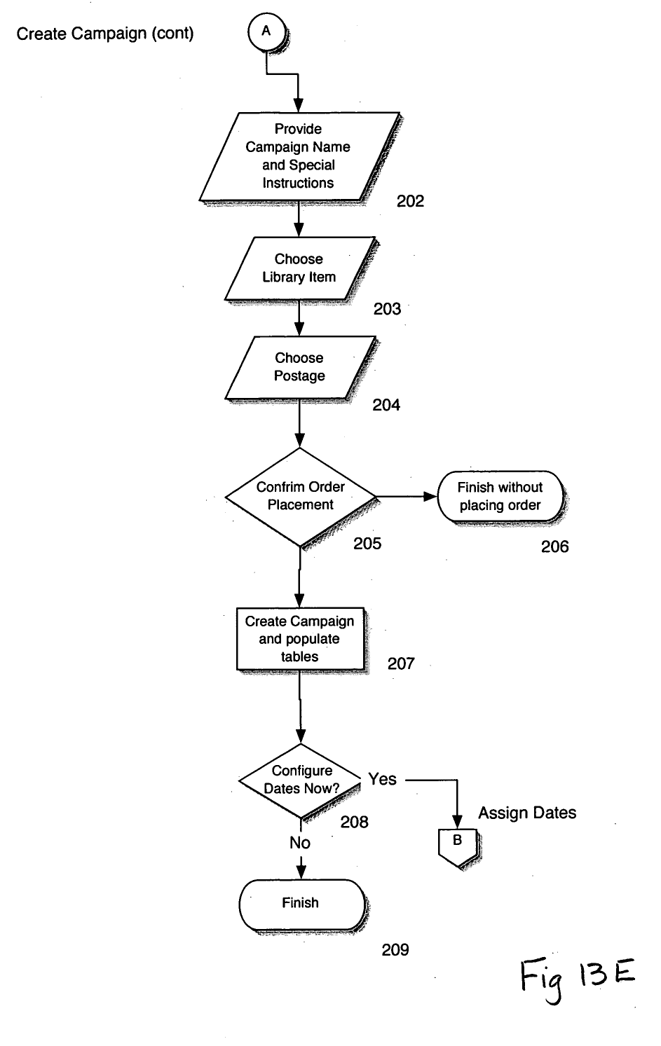

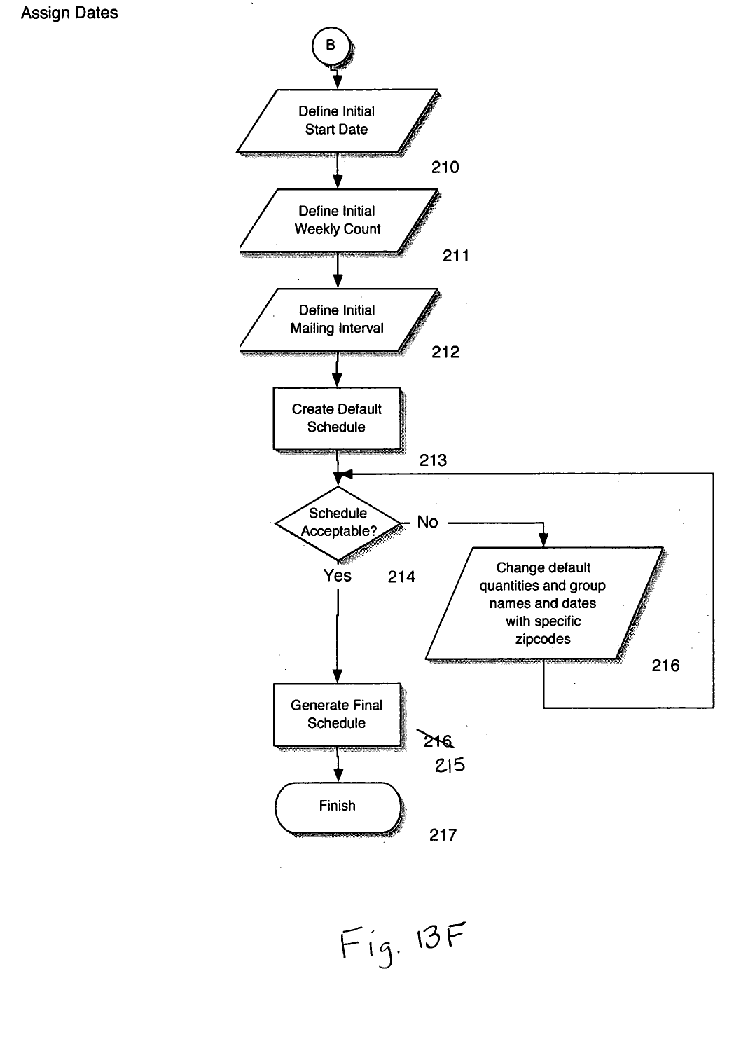

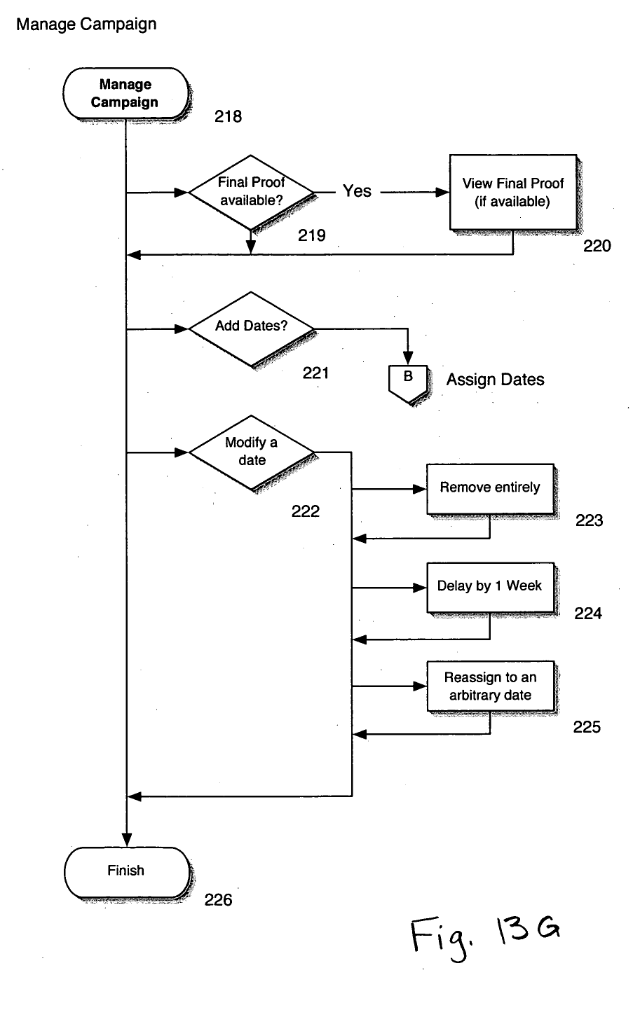

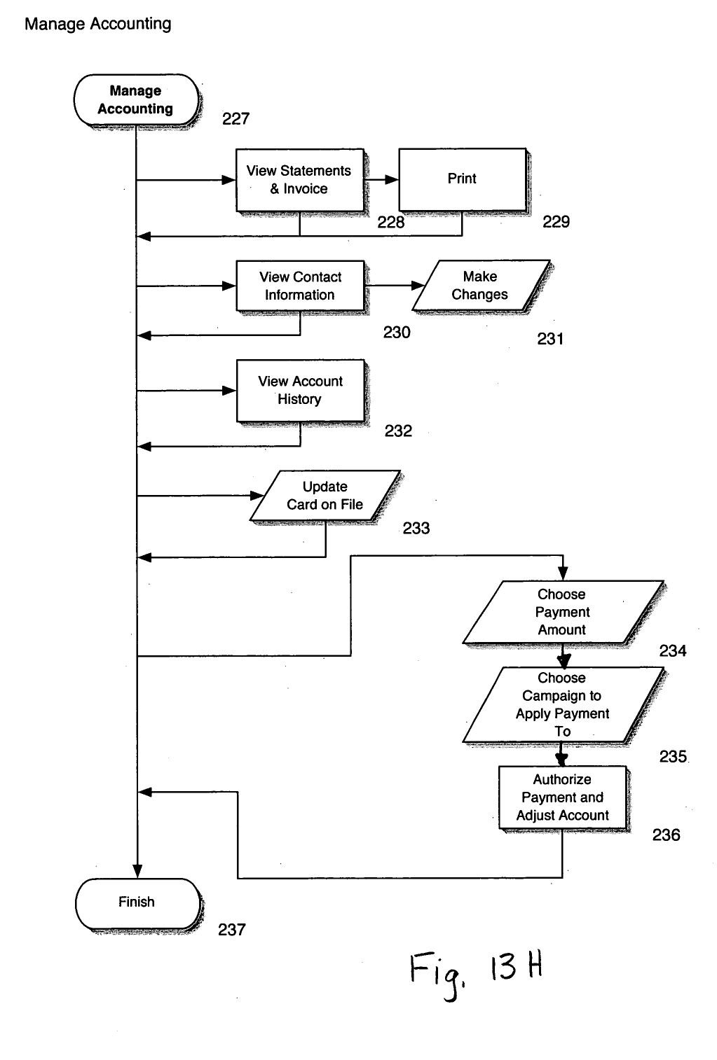

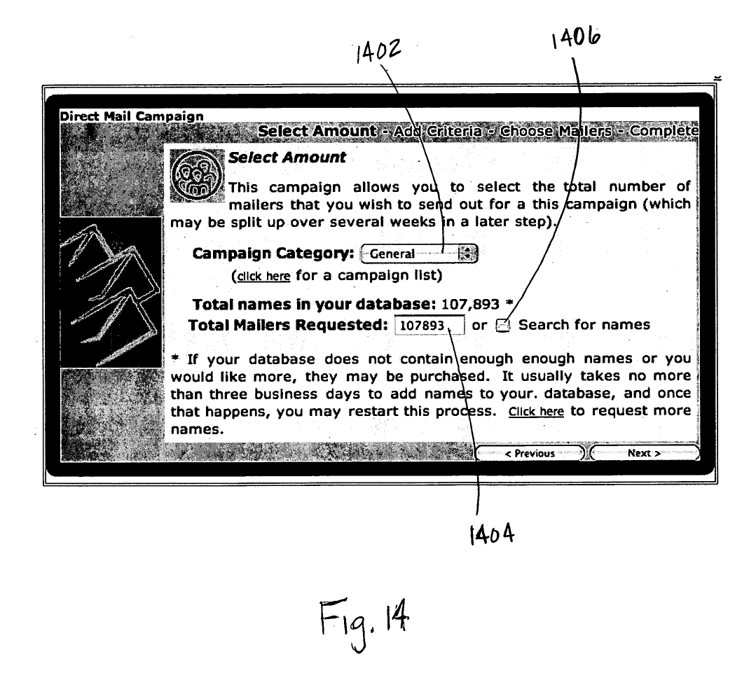

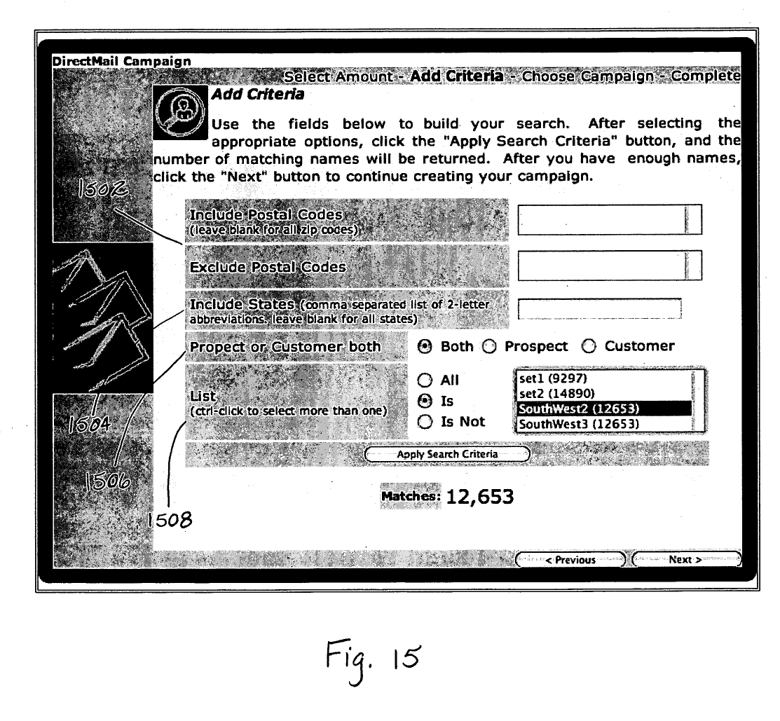

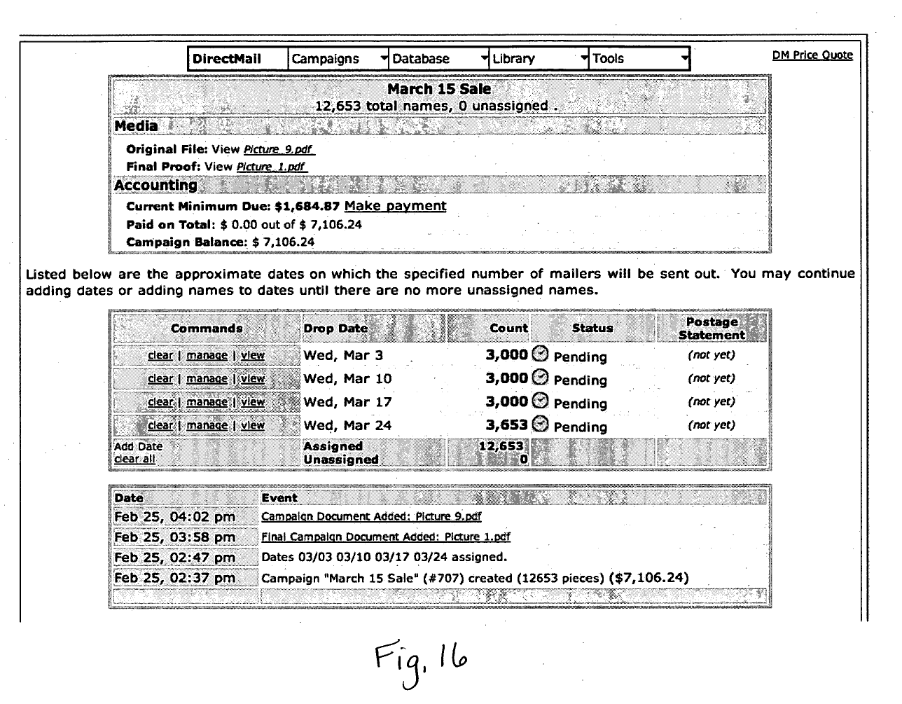

Referring to FIGS. 13A-13H and 14, a new company with an interest in marketing a custom mailer, accesses the user interface application via the Internet by logging on 167 a host web site, which may be one provided by a professional organization to which they are a member, fills out an online signup form, entering the information necessary for the system to create their user account. (All the Account Administrator has to do is approve or deny the application, and an e-mail is automatically dispatched to the new user).

When a user first logs in to the system, the only items of interest are the collection of mailers in the Library. As discussed, the Library will be populated with mailers pertinent to the user's industry assuming that the user account type allows for such access.

These documents have little value without a set of names to mail them to, so the recommended first step for a new user is to create their online database of names 168. The user is instructed to upload their database file 175, 176 or request names from an external data source 177 such as InfoUSA 174. The data file may be in plain-text format 175 or Microsoft® Excel™ format 176. The Database Administrator is responsible for importing the data into the user's account 179 in one embodiment of the invention.

For immediate results, plain-text file is the only real-time option 178. The user may create a plain-text file from virtually any application that handles data. The system expects this data to arrive in an unpredictable order with an unpredictable set of information for each record. When the system receives the file, it attempts to identify each column, and the user verifies and adjusts the type of each column 180. Plain text files do not commonly include column descriptors, but the system does some simple data matching to attempt to properly identify each column, (a column that contains only 5 numbers is probably a zip code . . . ) and determine the column separator.

The system is operable to allow the user to provide additional information 181. The user may include some demographic information, including house age, house value, estimated annual income, and length of residence. The user can include their own unique identifier for each record, to assist in tracking. The user may specify contact information, additional to standard mailing address information, such as phone number, fax number, and e-mail address.

Once each column is properly identified, the user names the set of records 180 associated with this import, such as “Mailing List”, and the system imports the data, automatically removing duplicates and creating a List based on the incoming data. The user receives a brief report of this process in their e-mail 182. Once the import process has completed 183, the user is taken to the main database screen. The main screen displays a set of records (a list, a campaign date), 20 at a time. The set is searchable and can also be sorted.

The user may edit the details of each record, add some notes, and view the record's history. The record may also be removed entirely from the database. The user may also obtain a list of “Bad Names”, which the system believes to be incomplete.

When editing the details, the user may specify whether or not the record should be excluded from a given campaign category. If the user knows that a particular record, for example, has recently replaced their air conditioning system, they should be excluded from any “Replacement” campaigns, marketing air conditioning system replacement. Campaign categories are initially defined by the Library Administrator, but the user may easily create a custom list, which may be as broad (“Replacement”) or as specific, (“Air Conditioning Replacement”) as needed.

A complete history for each record is also maintained. As time proceeds, each address record will contain a complete timeline of the events associated with it, such as when the record was created, the date of each campaign and if tracked by the user, the date of each call or visit. Initially, this history only contains the date the record was created.

The system provides Library management functionality 169. Once the database has been created, the user may wish to review, and modify one of the default mailer documents 184. The Library initially contains a list of these documents 186. The default documents may be written in generic language, and the user may receive a better response if the documents are personalized.

The user may add a custom document 185 to the Library (either locally created, or a modified default). When adding a document to the Library, the user describes the document Type (“3 Page Letter”) and mailer Category (“Replacement”, “Inspection”, . . . ) If there is an active campaign that has been created, the document may be assigned to the campaign 189. The document is given a name for identification purposes. The system also is operable to allow the user to customize predefined documents 187. If there is an active campaign that has been created, the document may be assigned to the campaign 190. The campaign may optionally be tagged as a permanent 191, 192, user-supplied Library item. This becomes useful for repeated campaigns, every year. If this option is not specified, the document is used only with the specified campaign.

Once a database has been imported, and a mailing document has been added and completed 193, a campaign may be created 170. Before beginning, the system is instructed to preload all records from the customer database 194, 195. The names are then optimized and ordered, as described earlier. This step speeds up the searching processes in the following steps item 1402.

The user selects the Campaign's Category 196. Also, see item 1402 FIG. 14 for a representative screen shot. Each record in the customer database may be excluded from a particular campaign category. Choosing the campaign category 1402 at the first step allows the system to remove those records immediately. The user also supplies a target number of mailers 196, 197, 1404 or may choose to perform a search 1406.

If specified, the user is taken to the Search step 198 in the creation process. The user may generate a list of records based on search criteria 199, including postal codes 1502 to include or exclude, a list of states 1504, one or more Lists or if the record has been tagged as a customer or a prospect 1506. If available, the user may also specify additional demographic criteria 1508. (“House Age is greater than 20 years”).

The system calculates the number of matches 200, allowing the user to further refine the search 201. This continues until the user is satisfied with the number of matches.

The user is prompted to give the campaign a unique name (“Summer Sale”) 202. The name, in addition to the order number, is used to identify the campaign during its lifetime. The user specifies the campaign's library item 203 at this point, and validates the type of media (“3 page black and white letter”, “color post card”, etc.), and chooses a postage type 204. (“First Class Stamp”) The system provides a total cost quote, broken down into Printing (which is taxable), and other mailing fees.

If acceptable 205, the user may provide some special instructions (“Use the ‘No Peak’ method of envelope insertion”). The user may modify the default return address, as some businesses have multiple offices. The payment type (“Check”, “Credit Card”, . . . ) is also selected.

The system is now ready to place the order, and enter the new campaign into the process of preparing it for mailing, and the user is asked to confirm this action 205. If not confirmed, the order is not placed 206. If the user confirms, the campaign is created and tables are populated, they are immediately billed, and the Printer is contacted about the new campaign 207. If the user so wishes, the schedule may be specified immediately 208, or at a later time 209. Printing of the media proceeds even without a defined schedule.

The number of mailers in a particular campaign may be mailed all at once, or spread out over a defined schedule. The user is prompted for the start date of the campaign 210. The user is asked how many pieces per week they want to send, with a Mail House Administrator-defined weekly minimum 211. The user is asked how often the mailers should be sent (weekly, monthly, etc. . . . ) 212.

The next step in the process creates a simple, preliminary schedule, which includes a target number of mailers 213, and a date generated by the previous options, avoiding weekends and holidays. The user is allowed to adjust the quantities 214. The user may optionally specify which zip codes (or Lists) should be included in each date, allowing for some geographic organization 216. For reference, the system provides a table of the number of names in each zip code, to assist the user in creating the schedule. Often, the last week in the preliminary schedule contains less than the mail house-imposed limit of minimum number of pieces per week. In this case, this remaining amount is added to the previous week.

Once all the information has been collected, the final schedule is generated by the system 215, 217. If no zip codes or lists are provided for a particular date, the system creates an ordered list of names based on zip codes, to introduce some limited geographic organization (to avoid targeting a large metropolitan area versus a small section in one mailing). If zip codes or lists are provided for a particular date, the system assigns names from that zip code or list first, until the limit for that date is reached. If the number of names gathered from zip codes or lists is less than the limit, the system assigns names to the remaining slots using the sorted zip code method. If the number of names gathered from the zip codes or lists is greater than the limit, the system stops at the limit, leaving those names in the specified zip code temporarily unassigned. A later date will eventually get assigned to those names.

After adding any dates, the user returns to the campaign management area 171, 218. The Management screen, see FIG. 16, allows the user to add or remove dates, to upload (or approve) a document, view a final proof and view the campaign's status and history, or make payments. If there are any names without any dates assigned, a high-visibility link to add those names is displayed. The page displays the campaign's current Minimum Due (the payment required in order to send the mailers for the next drop date), with a Make Payment link nearby. If the minimum due has not been met, the Mail House Administrator will not perform the mailing. The page also displays payment history showing how much out of the total was paid, as well as the current campaign balance. Postage Statements for each “drop date” are available, if the Mail House Administrator has already uploaded them.

Throughout the course of a campaign, the user receives e-mail notifications of the required payment information. Payments may be made at any time through a secured, online, real-time payment mechanism.

The user may also update the default card on file, used for automatic bill payment, as well as the bill-to e-mail address. Contact information (mailing address) may also be updated.

The user may view any past or present invoice, as well as a financial statement detailing the transactions of a given period. The statements are available by month, by quarter or by year.

A complete history of all user and campaign activity is also viewable. The history contains when campaigns were created, when each campaign was dropped, when new databases were uploaded, when payments were made or bills sent, and even when the user logged in.

1. An wide area network based direct mail system comprising:
a host server accessible via a wide area network having an executable direct mail system application residing thereon where when executed is operable to upload and download data to and from a contact database and a campaign library responsive to a user input where said database and library are communicable with said server; and
a campaign development user interface function generated when the direct mail system application is executed and accessible over the wide area network where said campaign development user interface is operable to receive and execute inputs directing the direct mail system application to create a mail campaign by downloading and assembling a set of contact addresses from the contact database and associating the set with a campaign mailer downloaded from the campaign library responsive to the user inputs and providing the mail campaign via the wide area network to a fulfillment printer and mail house.

2. A system as recited in claim 1, further comprising:
a campaign management user interface function generated when the direct mail system application is executed and accessible over the wide area network where said campaign management user interface is operable to receive and execute user inputs directing the direct mails system application to present real time status of the mail campaign from creation to fulfillment.

3. A system as recited in claim 1, further comprising:
a contact management user interface function generated when the direct mail system application is executed and accessible over the wide area network where said contact management user interface is operable to track contact history based on fulfilled campaigns and contact information input by the user and further operable to present the contact history for viewing via the contact management user interface.

4. A system as recited in claim 1, further comprising:
an account administration user interface function generate when the direct mail system application is executed and accessible over the wide area network where said account administration user interface is operable to establish user accounts, manage the contact database, manage financial data related to the campaign and maintain the direct mail system application.

5. A system as recited in claim 1, further comprising:
a library administration user interface function generated when the direct mail system application is executed and accessible over the wide area network where said library administration user interface is operable to upload current campaign mailer documents input by a library administrator to the campaign library and further operable to control access to the uploaded campaign mailer documents based on library administrator inputs.

6. A system as recited in claim 1, further comprising:
a mail house administration user interface function generated when the direct mail system application is executed and accessible over the wide area network where said mail house administration user interface is operable to present print status to a mail house administrator and further operable to merge the set of contact addresses with the mailers.

7. A system as recited in claim 6, further comprising:
a printer administration user interface function generated when the direct mail system application is executed and accessible over the wide area network where said printer administration user interface is operable to present to a printer administrator all campaigns provided for printing and further operable to receive print documents input by the print administrator.

8. A method for performing a wide area network based mailer distribution process comprising the steps of:
providing a host server accessible via a wide area network and executing a mail house distribution application residing thereon operable to upload and download data to and from a contact database and a campaign library responsive to a user input where said database and library are communicable with said server; and
generating a campaign development user interface function generated when the direct mail system application is executed that is accessible over the wide area network where said campaign development user interface is operable to receive and execute inputs directing the direct mail system application to create a mail campaign by downloading and assembling a set of contact addresses from the contact database and associating the set with a campaign mailer downloaded from the campaign library responsive to the user inputs and providing the mail campaign via the wide area network to a fulfillment printer and mail house.

9. A system as recited in claim 8, further comprising:
generating a campaign management user interface function when the direct mail system application is executed such that it is accessible via the wide area network and is operable to receive and execute user inputs directing the direct mails system application to present real time status of the mail campaign from creation to fulfillment

10. A system as recited in claim 8, further comprising:
generating a contact management user interface function when the direct mail system application is executed such that it is accessible via the wide area network and is operable to track contact history based on fulfilled campaigns and contact information input by the user and further operable to present the contact history for viewing via the contact management user interface.

11. A system as recited in claim 8, further comprising:
generating an account administration user interface function when the direct mail system application is executed such that it is accessible over the wide area network where said account administration user interface is operable to establish user accounts, manage the contact database, manage financial data related to the campaign and maintain the direct mail system application.

12. A system as recited in claim 8, further comprising:
generating a library administration user interface function generated when the direct mail system application is executed that is accessible over the wide area network where said library administration user interface is operable to upload current campaign mailer documents input by a library administrator to the campaign library and further operable to control access to the uploaded campaign mailer documents base on library administrator inputs.

13. A system as recited in claim 8, further comprising:
generating a mail house administration user interface function generated when the direct mail system application is executed such that it is accessible over the wide area network where said mail house administration user interface is operable to present print status to a mail house administrator and further operable to merge the set of contact addresses with the mailers.

14. A system as recited in claim 13, further comprising:
generating a printer administration user interface function generated when the direct mail system application is executed that is accessible over the wide area network where said printer administration user interface is operable to present to a printer administrator all campaigns provided for printing and further operable to receive print documents input by the print administrator.

15. A wide area network based user interface for mailer distribution comprising;
a campaign development user interface function accessible over a wide area network where said user interface is operable to receive and upload over the wide area network contact address data to a contact database and receive and upload campaign mailer documents to a campaign mailer library and is further operable to receive and execute inputs to create a mail campaign by downloading and assembling a set of contact addresses from the database and associating the set with a campaign mailer from the library responsive to the inputs and providing the mail campaign via the wide area network to a fulfillment printer and mail house.

16. The mailer distribution system as recited in claim 15, comprising:
a contact management functional user interface accessible via a wide area network and integral with the campaign development user interface function operable to track contact history based on fulfilled campaigns and contact information input by the user and further operable to present the contact history for viewing via the contact management user interface.

17. The mailer distribution system as recited in claim 16, comprising:
a campaign management functional user interface accessible via a wide area network and integral with the campaign development and contact management user interface functions operable to receive and execute user inputs directing the direct mails system application to present real time status of the mail campaign from creation to fulfillment.

18. The mailer distribution system as recited in claim 17, comprising:
an account administration user interface function accessible via the wide area network and integral with the campaign development and contact management and campaign management user interface functions operable to establish user accounts and maintain the direct mail system application.

19. The Mailer distribution system as recited in claim 17, comprising:
a library administration user interface function accessible via the wide area network and integral with the campaign development and contact management and campaign management user interface functions operable to control access to the uploaded campaign mailer documents base on library administrator inputs.

20. The mailer distribution system as recited in claim 17, comprising:
a mail house administration user interface function accessible via the wide area network and integral with the campaign development and contact management and campaign management user interface functions operable to operable to present print status to a mail house administrator and further operable to merge the set of contact addresses with the mailers.
a printer administration user interface function accessible via the wide area network and integral with the campaign development and contact management and campaign management user interface functions operable to present to a printer administrator all campaigns provided for printing and further operable to receive and upload print status and print proofs input by the print administrator.
